(19) United States
(12) Patent Application Publication
(10) Pub. No.: US 2006/0269768 A1
(43) Pub. Date: Nov. 30, 2006

(54) Method of alkali saponifying polymer film, surface-saponified cellulose ester film and optical film

(75) Inventor: Kunio Mutou, Odawara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO. LTD., Minami-Ashigara-shi (JP)

(21) Appl. No.: 11/439,963

(22) Filed: May 25, 2006

(30) Foreign Application Priority Data
May 25, 2005 (JP) 2005-152510

(51) Int. Cl. B32B 23/00; B05D 3/02; B05D 1/40

(52) U.S. Cl. 428/532; 427/314; 427/331

(57) ABSTRACT

A for alkali saponifying a polymer film is provided and includes the steps of: coating a polymer film at room temperature or higher with an alkali solution having specific ratios among an alkali, a high-boiling solvent, water and water; and the step of washing away the alkali solution from the polymer film.

### FIELD OF THE INVENTION

This invention relates to a method of alkali saponifying a polymer film. More specifically, this invention relates to a method of alkali saponifying a cellulose ester film, which is advantageously usable as a transparent support for a continuous optical compensation sheet. This invention also relates to a surface-saponified cellulose ester film, which is produced by the alkali saponification method and an optical film including the surface-saponified cellulose ester film.

### BACKGROUND OF THE INVENTION

A liquid crystal display includes a liquid crystal cell, a polarizing plate and an optical compensation sheet (a retardation plate). In a liquid crystal display of the transmission type, a polarizing plate is provided in each side of a liquid crystal cell and one or more optical compensation sheets are further provided between the liquid crystal cell and the polarizing plate. A liquid crystal display of the reflection type includes a reflection plate, a liquid crystal cell, an optical compensation sheet and a polarizing plate. A liquid crystal cell includes rod-shaped liquid crystal molecules, two substrates for enclosing these molecules and an electrode layer for applying voltage on the rod-shaped liquid crystal molecules. Concerning liquid crystal cells, there have been proposed various display modes depending on the orientation state of rod-shaped liquid crystal molecules, for example, TN (twisted nematic), IPS (in-plane switching), FLC (ferroelectric liquid crystal), FLC (ferroelectric liquid crystal), OCB (optically compensatory bend), STN (super twisted nematic) and VA (vertically aligned) modes for the transmission type and HAN (hybrid aligned nematic) modes for the reflection type. A polarizing plate generally includes a polarizer and a pair of transparent protective films provided in both sides thereof. The polarizer can be obtained generally by dipping a polyvinyl alcohol film in an aqueous solution of iodine or a dichroic dye and then uniaxially stretching the film.

Optical compensation sheets have been employed in various liquid crystal displays to prevent image coloration or enlarge viewing angle. As such optical compensation sheets, it has been a common practice to employ stretched birefringent films. As a substitute for such an optical compensation sheet comprising a stretched birefringent film, it has been proposed to use an optical compensation sheet having an optically anisotropic layer formed by liquid crystal molecules (in particular, discotic liquid crystal molecules) on a transparent support. The optically anisotropic layer is formed by orientating liquid crystal molecules and fixing in the orientation state. In general, liquid crystal molecules having polymerizable group are used and fixed in the orientation state due to polymerization. A liquid crystal molecule has a high birefringence and there are various orientation states of liquid crystal molecules. By using liquid crystal molecules in an optical compensation sheet, therefore, optical characteristics that cannot be obtained by the existing stretched birefringent films can be established.

The optical properties of an optical compensation sheet are designed depending on the optical properties of a liquid crystal cell, more specifically speaking, differences in the display modes of liquid crystal cells as discussed above. By designing optical compensation sheets with the use of liquid crystal molecules (in particular, discotic liquid crystal molecules), optical compensation sheets having various optical characteristics adequate for various liquid crystal display modes can be fabricated. There have been proposed optical compensation sheets with the use of discotic liquid crystal molecules adequate for various display modes. More specifically speaking, there have been proposed optical compensation sheets for TN mode liquid crystal cells (see, for example, JP-A-6-214116, U.S. Pat. No. 5,583,679, U.S. Pat. No. 5,646,703, West Germany Patent 3,911,620), optical compensation sheets for IPS mode or FLC mode liquid crystal cells (see, for example, JP-A-10-54982), optical compensation sheets for OCB mode or HAN mode liquid crystal cells (see, for example, U.S. Pat. No. 5,805,253 and WO 96/37804), optical compensation sheets for STN mode liquid crystal cells (see, for example, JP-A-9-26572) and optical compensation sheets for VA mode liquid crystal cells (see, for example, Japanese Patent No. 2866372).

By stacking an optical compensation sheet using liquid crystal molecules and a polarizer to form an elliptical polarizing plate, the optical compensation sheet can also serve as a transparent protective film in one side of the polarizing plate. An elliptical polarizing plate of such type has a layered structure including a transparent protective film, a polarizer, a transparent support and an optically anisotropic layer formed by liquid crystal molecules having been stacked in this order. Since a liquid crystal display should be microthin and lightweight, a thinner and lighter device can be obtained by employing one of the constituting element (i.e., both as a transparent protective film and an optical compensation sheet). By omitting one of the constituting elements of the liquid crystal display, moreover, one step of bonding the constituting element can be also omitted. This is favorable since the risk of failures in the course of fabricating the device can be likely lessened thereby. An integrated elliptical polarizing plate in which a transparent support of an optical compensation sheet using liquid crystal molecules also serves as the one-sided protective film of the polarizing plate has been proposed in practice (see, for example, JP-A-7-191217, JP-A-8-21996 and JP-A-8-94838).

In the case of such an optical compensation sheet or integrated elliptical polarizing plate as described above is used in a liquid crystal cell display device, micro unevenness sometimes occur on the display screen. It is clarified part of the reason for this problem resides in the unevenness in the thickness of the transparent support employed in the optical compensation sheet.

In the case of fabricating an optical compensation sheet provided with an orientation film and an optically anisotropic layer having fixed liquid crystal molecules on a transparent support, close adhesion should be achieved between the transparent support (usually a cellulose ester film typified by a cellulose acetate film) and the orientation film (usually polyvinyl alcohol). Since a cellulose ester film has a poor affinity for polyvinyl alcohol, peeling and cracking would occur at the interface. To prevent these, it has been a practice to provide a gelatin undercoating layer on the cellulose ester film. To achieve the close adhesion of the undercoating layer to the cellulose ester film, however, it is required to employ a solvent capable of penetrating into the cellulose ester film (for example, a ketone-based solvent) as the solvent of the coating solution for forming the gelatin undercoating layer. As a result, the cellulose ester film swells and then shrinks in the subsequent drying step, which results in a problem of the formation of microcurves in the film. When an orientation film and a liquid crystal molecule layer are successively formed on the thus curved film, there arise unevenness in the thickness of the orientation film or the liquid crystal molecule layer and unevenness in the orientation of the liquid crystal molecules following the microruved shape. Namely, it is found out that the image qualities of a liquid crystal display are thus worsened.

As a common method of improving the adhesion between a cellulose ester film and a hydrophilic material (for example, an orientation film) without resorting to a gelatin undercoating layer, there has been known a method which comprises dipping a film in an aqueous alkali solution, i.e., a so-called saponification bath treatment. Such a saponification method is described in detail in, for example, JP-A-8-94838. By this saponification bath treatment by dipping, however, the cellulose ester film is saponified in both faces at the same time. In the case of forming a hydrophilic layer such as a polyvinyl alcohol layer on one face and then rolling the film, the front and back faces of the film adhere together. As a technique for making one face alone hydrophilic, a method of making the non-target face waterproof by, for example, stacking and then conducting the saponification treatment may be cited. However, this method is not favorable from the viewpoints of productivity and environmental preservation, since it requires additional complicated procedures and an unnecessary by-product is formed.

The adhesion of the front and back faces, which generally arises in the existing saponification bath method as discussed above, can be improved by using an alkali saponification method comprising coating one face alone of a polymer film with an alkali saponification solution by using a rod coater, a die coater, a roll coater or the like, saponifying the one face alone in the step of maintaining the film at a definite temperature and then washing off the alkali solution form the polymer film. By adding an organic solvent to the alkali solution, the saponification reactivity can be elevated compared with a pure water solvent. As a result, the coating speed can be elevated, which results in an improvement in the productivity (see, JP-A-2003-313326).

At an elevated coating speed, however, it is needed to increase the coating amount per unit area in order to maintain the coating properties. Moreover, there are a heavy load treating wastewater resulted from the saponification treatment

### SUMMARY OF THE INVENTION

An object of an illustrative, non-limiting embodiment of the invention is to prevent the increase in the coating amount of an alkali saponification solution caused by an elevated coating speed so as to save the material cost and reduce the load treating wastewater in the one-face alkali saponification method of the coating mode.

Under these circumstances, the inventors have conducted intensive studies and consequently found that the above objects can be achieved by lowering the contents of an alkali and a high-boiling solvent in the alkali saponification solution based on the content of a low-boiling solvent, thereby completing the invention. That is to say, the above objects can be established preferably by the following methods.

(1) A method for alkali saponifying a polymer film, which includes the steps of: coating a polymer film at room temperature or higher with an alkali solution, wherein the mass ratio (weight ratio) of an alkali:a high-boiling solvent:water falls within the range of 1:(2 to 4):(2 to 4), and the mass ratio of (alkali+high-boiling solvent+water):low-boiling solvent falls within the range of 25:75 to 2:98; and washing away the alkali solution from the polymer film.

That is, the alkali solution (alkali saponification solution) used in an aspect of the invention includes an alkali (an alkali agent), a high-boiling solvent, a low-boiling solvent, and water. In the alkali solution, a weight ratio of the high-boiling solvent to the alkali is from 2 to 4, a weight ratio of the water to the alkali is from 2 to 4, and a weight ratio of (the alkali+the high-boiling solvent+the water) to the low-boiling solvent is from 25:75 to 2:98.

(2) A method for alkali saponifying a polymer film, which comprises the steps of: coating a polymer film at room temperature or higher with an alkali solution, wherein the mass ratio of an alkali:a high-boiling solvent:water falls within the range of 1:(2 to 4):(2 to 4), and the mass ratio of (alkali+high-boiling solvent+water):low-boiling solvent falls within the range of 25:75 to 2:98; maintaining the temperature of the polymer film at room temperature or higher; and washing away the alkali solution from the polymer film.

(3) A method for alkali saponifying a polymer film, which comprises the steps of preliminarily heating a polymer film at room temperature or higher; coating the polymer film with an alkali solution, wherein the mass ratio of an alkali:a high-boiling solvent:water falls within the range of 1:(2 to 4):(2 to 4), and the mass ratio of (alkali+high-boiling solvent+water):low-boiling solvent falls within the range of 25:75 to 2:98; maintaining the temperature of the polymer film at room temperature or higher; and washing away the alkali solution from the polymer film.

(4) The method as described in any one of the above (1) to (3), wherein each of the steps is performed while transporting the polymer film.

(5) The method as described in the above (4), wherein the polymer film is continuously transported.

(6) The method as described in any one of the above (1) to (5), wherein the concentration of the alkali solution is from 0.05 to 1 mol/l, and the coating amount of the alkali solution is from 1 to 500 cc/m².

(7) The method as described in any one of the above (1) to (6), wherein the alkali agent is an alkali metal hydroxide, and at least one of the high-boiling and low-boiling solvents includes one or more organic solvents selected from the group consisting of alcohols having 8 or less carbon atoms, ketones having 6 or less carbon atoms, esters having 6 or less carbon atoms and polyhydric alcohols having 6 or less carbon atoms.

(8) The method as described in any one of the above (1) to (7), wherein the alkali solution includes at least one surfactant selected from the group of consisting of a nonionic surfactant, an anionic surfactant, a cationic surfactant and an amphoteric surfactant.

(9) The method as described the above (8), wherein the concentration of the surfactant is from 0.05 to 5% by mass (weight).

(10) The method as described in the above (8) or (9), wherein the surfactant is a represented by the following formula (1):
R¹-L¹-Q¹
wherein R¹ represents an alkyl group having 8 or more carbon atoms; L¹ represents a group linking R¹ and Q¹, and L¹ represents a direct bond or a divalent liking group; and Q¹ represents a nonionic hydrophilic group or an anionic hydrophilic group.
(11) The method as described in any one of the above (8) to (10), wherein the surfactant is a nonionic surfactant represented by the following formula (2):
R²-L²-Q²
wherein R² and L² have the same meanings respectively as R¹ and L¹ in the formula (I); and Q² represents a nonionic hydrophilic group selected from among a polyoxyethylene unit (degree of polymerization: 5 to 150), a polyglycerol unit (degree of polymerization: 3 to 30) and a hydrophilic sugar chain unit.
(12) The method as described in any one of the above (8) to (10) wherein the surfactant is an anionic surfactant represented by the following formula (3):
R³-L³-Q³
wherein R³ has the same meaning as R¹ in the formula (1); L³ represents a divalent linking group having a polar partial structure obtained by combining units selected from the group consisting of —O—, —CO—, —NR⁵— (wherein R⁵ represents an alkyl group having from 1 to 5 carbon atoms), —OH, —CH═CH— and —SO₂—; and Q³ represents an anionic group.
(13) The method as described in any one of the above (1) to (12), wherein the surface tension of the alkali saponification solution is not more than 45 mN/m, and the viscosity of the alkali saponification solution is from 0.8 to 20 mPa·s.
(14) The method as described in any one of the above (1) to (13), wherein the density of the alkali saponification solution is from 0.65 g/cm³ to 1.05 g/cm³.
(15) The method as described in any one of the above (1) to (14), wherein the electric conductivity of the alkali saponification solution is from 1 mS/cm to 100 mS/cm.
(16) The method as described in any one of the above (1) to (15), wherein the polymer film is a cellulose ester film.
(17) A surface-saponified cellulose ester film, which is produced by a method as described in the above (16).
(18) An optical film including a surface-saponified cellulose ester film as described in the above (17).

### DETAILED DESCRIPTION OF THE INVENTION

Next, exemplary embodiments of the invention will be illustrated in greater detail.

The expression “a high-boiling solvent” as used herein means a solvent having a boiling point of 100° C. or higher, while the expression “a low-boiling solvent” as used herein means a solvent having a boiling point of lower than 100° C.

To reduce the coating dose per unit area having been increased by elevating the coating speed, it seems effective to lower the viscosity of the saponifying solution.

It also seems that the wastewater load resulted from the saponification treatment can be reduced by lowering the content of a high-boiling organic solvent (for example, propylene glycol (188° C.)) in the saponification solution.

The viscosity of the high-boiling solvent in the saponification solution is higher than the viscosities of the low-boiling solvent (for example, isopropyl alcohol (82° C.)) and pure water. To lower the viscosity of the saponifying solution, it is therefore effective to lower the composition ratio of the high-boiling solvent. Thus, the high-boiling solvent ratio in the saponifying solution is lowered to, for example, high-boiling solvent ratio of 11.5, compared with the existing saponification solutions, the composition ratio of which, for example, alkali 5:high-boiling solvent 15:pure water 15:low-boiling solvent 64. As a result, the low-boiling solvent and water are separated due to the localization of the alkali (for example, potassium hydroxide) to form two phases.

As the results of studies aiming at prevent the separation into two phases, it is found that by lowering the alkali concentration (for example, an alkali ratio of 2.5), the ratio of the high-boiling solvent can be largely lowered (to, for example, a high-boiling solvent ratio of 8) while preventing the separation into two phases.

When the saponification reaction speed is evaluated based on the contact angle-lowering speed in the case of reducing the alkali concentration and the high-boiling solvent, it is observed that the saponification reactivity is largely worsened in the case of reducing the alkali concentration alone but the saponification reactivity is restored by reducing the high-boiling solvent together.

As the results of studies on the effects of pure water on the phase separation, it is found out that the phase separation would not arise even at a high high-boiling solvent content in the case of using less pure water.

Furthermore, the addition levels of the alkali, the high-boiling solvent and pure water are widely varied. As the results of this test, it is clarified that the solution remains stable without undergoing phase separation and the saponification reactivity is not so seriously worsened when the three components (the alkali, the high-boiling solvent and pure water) are reduced at almost the same ratio, i.e., alkali:high-boiling solvent:water being 1:(2 to 4):(2 to 4), while (alkali+high-boiling solvent+water):low-boiling solvent being 25:75 to 2:98.

When the ratio of the low-boiling solvent is lowered, there arises the phase separation, and when the ratio of the low-boiling solvent is raised, the saponification speed is lowered. When the ratio of water is lowered, K₂CO₃ (a product formed by the reaction between the alkali and carbon dioxide gas in the atmosphere) separates out. When the ratio of water is elevated, the saponification speed is lowered.

In the step of maintaining the film temperature at a definite level following the coating, the low-boiling solvent is mainly evaporated. Therefore, the composition of the saponification solution comes close to the composition of the existing saponification solutions during the temperature-maintaining step and then the step of washing off the saponification solution is conducted.

When the addition levels of the alkali and the high-boiling solvent are lowered, the viscosity and density of the saponification solution are both lowered, which makes it possible to reduce the coating amount under the same coating conditions.

In this case, the contact angle is elevated with the decrease in the addition levels. It is found out that the contact angle can be maintained at a desired level (45°) or less even though reducing the amounts of the three components (the alkali, the high-boiling solvent and pure water) to ⅙.

As discussed above, a characteristic of the invention resides in using a saponification solution wherein the three components (the alkali, the high-boiling solvent and pure water) are reduced at almost the same ratio based on the low-boiling solvent, i.e., alkali:high-boiling solvent:water being 1:(2 to 4):(2 to 4), while (alkali+high-boiling solvent+water):low-boiling solvent being 25:75 to 2:98, compared with the existing saponification solutions (for example, alkali 5:high-boiling solvent:15, pure water:15, low-boiling solvent 64).

Next, constituting elements employed in an exemplary embodiment of the invention such as materials and methods will be described in greater detail.

(Polymer Film)

As the polymer film, it is preferable to use a one having a light transmittance of 80% or higher. As the polymer film, one developing little birefringence due to external force is preferred. The polymer film contains a hydrolyzable bond (i.e., the bond to be saponified) such as ester bond or amide bond. Ester bond is preferred and ester bond occurring in a side chain of the polymer is more preferred. As typical examples of a polymer having ester bond in its side chain, cellulose esters may be cited. A lower fatty acid ester of cellulose is more preferred, cellulose acetate is more preferred, and cellulose acetate having a degree of acetylation of from 59.0 to 61.5% is most desirable. The expression “degree of acetylation” means the amount of acetic acid bonded per unit mass (weight) of cellulose. The degree of acetylation is measured and calculated in accordance with ASTM-D817-91 (Test Method of Cellulose Acetate, etc.).

The viscosity-average degree of polymerization (DP) of the cellulose ester is preferably 250 or more and more preferably 290 or more. It is preferable that the cellulose acylate to be used in the invention has a small molecular weight distribution Mw/Mn (Mw: mass-average (weight-average) molecular weight, Mn: number-average molecular weight) determined by gel permeation chromatography. More specifically speaking, Mw/Mn preferably ranges from 1.0 to 1.7.

In the case of using the polymer film in an optical compensation sheet, it is preferred that the polymer film has high retardation values. The Re retardation value and the Rth retardation value of a film are represented respectively by the following formulae (I) and (II).
Re=|nx−ny|xd (I)
Rth={(nx+ny)/2−nz}xd (II)

In the above formulae (I) and (II), nx indicates the refractive index in the slow axis direction in the film plane (the direction with the maximum refractive index; ny indicates the refractive index in the fast axis direction in the film plane (the direction with the minimum refractive index); nz indicates the refractive index in the film thickness direction; and d indicates the film thickness expressed in nm. The Re retardation value of the polymer film preferably ranges from 1 to 200 nm, while the Rth retardation value thereof preferably ranges from 70 to 400 nm. In practice, the retardation values are determined by extrapolating the measurement data obtained by inclining the incident light from the normal direction of the film plane. The measurement can be made with the use of an ellipsometer (for example, M150 manufactured by JASCO ENGINEERING). The measurement wavelength is 632.8 nm (He—Ne laser).

The retardation of a polymer film is generally controlled by applying an external force by, for example, stretching. Alternatively, a retardation rising agent for controlling optical anisotropy may be added in some cases. In order to control the retardation of a cellulose acylate film, it is preferable to employ as a retardation raising agent an aromatic compound having at least two aromatic rings. Such an aromatic compound may be preferably used in an amount of from 0.01 to 20 parts by mass (weight) per parts by mass (weight) of cellulose acylate. It is also possible to use two or more aromatic compounds together. The aromatic rings in these aromatic compounds involve not only aromatic hydrocarbon rings but also aromatic hetero rings. As examples thereof, compounds described in EP 0911656, JP-A-20000-111914 and JP-A-2000-275434 may be cited. The molecular weight of the retardation raising agent preferably ranges from 300 to 800.

It is preferable to produce the polymer film by the solvent casting method. In the solvent casting method, the film is produced by using a solution (dope) having a polymer material dissolved in an organic solvent. The organic solvent is preferably selected from an ether having from 3 to 12 carbon atoms, a ketone having from 3 to 12 carbon atoms, an ester having from 3 to 12 carbon atoms, and a halogenated hydrocarbon having from 1 to 6 carbon atoms. The ether, the ketone and the ester may each have a cyclic structure. A compound containing any two or more of functional groups of the ether, the ketone and the ester (that is, —O—, —CO—, and —COO—) can also be used as the organic solvent. The organic solvent may contain other functional group such as an alcoholic hydroxyl group. In the case of an organic solvent containing two or more kinds of functional groups, it is preferable that the number of carbon atom thereof falls within the foregoing preferred range of the number of carbon atom of the solvent containing any functional group.

Examples of the ether having from 3 to 12 carbon atoms include diisopropyl ether, dimethoxymethane, dimethoxyethane, 1,4-dioxane, 1,3-dioxolan, tetrahydrofuran, anisole, and phenetole. Examples of the ketone having from 3 to 12 carbon atoms include acetone, methyl ethyl ketone, diethyl ketone, diisobutyl ketone, cyclohexanone, and methylcyclohexanone. Examples of the ester having from 3 to 12 carbon atoms include ethyl formate, propyl formate, pentyl formate, methyl acetate, ethyl acetate, and pentyl acetate. Examples of the organic solvent containing two or more kinds of functional groups include 2-ethoxyethyl acetate, 2-methoxyethanol, and 2-butoxyethanol. The number of carbon atom of the halogenated hydrocarbon is preferably 1 or 2, and most preferably 1. The halogen of the halogenated hydrocarbon is preferably chlorine. A proportion of the hydrogen atom of the halogenated hydrocarbon as substituted with the halogen is preferably from 25 to 75% by mole, more preferably from 30 to 70% by mole, further preferably from 35 to 65% by mole, and most preferably from 40 to 60% by mole. Methylene chloride is a representative halogenated hydrocarbon. It is also possible to use a mixture of two or more organic solvents.

The polymer solution can be prepared by a general method including the treatment at a temperature of 0° C. or higher (ordinary temperature or high temperature). The preparation of the solution can be carried out by using a preparation method of a dope and a device in the usual solvent casting method. Incidentally, in the case of the general method, it is preferred to use a halogenated hydrocarbon (in particular, methylene chloride) as the organic solvent. The amount of the polymer is preferably adjusted such that it is contained in an amount of from 10 to 40% by mass (weight) in the resulting solution. The amount of the polymer is more preferably from 10 to 30% by mass. An arbitrary additive as described later may be added in the organic solvent (prime solvent). The solution can be prepared by stirring the polymer and the organic solvent at the ordinary temperature (from 0 to 40° C.). The solution with high concentration may be stirred under a pressurizing and heating condition. Concretely, the polymer and the organic solvent are charged in a pressure vessel, and after closing the vessel, the mixture is stirred under a pressure while heating at a temperature in the range of from the boiling point of the solvent under atmospheric pressure to a temperature at which the solvent is not boiled. The heating temperature is usually 40° C. or higher, preferably from 60 to 200° C., and more preferably from 80 to 110° C.

The individual components may be previously roughly mixed and then charged in the vessel. Alternatively, they may be successively charged in the vessel. The vessel must be constructed such that stirring can be achieved. The vessel can be pressurized by injecting an inert gas such as a nitrogen gas. Furthermore, an increase of the vapor pressure of the solvent due to heating may be utilized. Alternatively, after closing the vessel, the respective components may be added under a pressure. In the case of heating, it is preferable that the heating is carried out from the outside of the vessel. For example, a jacket type heating device can be employed. Furthermore, the whole of the vessel can be heated by providing a plate heater in the outside of the vessel, piping and circulating a liquid. It is also preferred to provide a stirring blade in the inside of the vessel and perform stirring using it. As the stirring blade, one having a length such that it reaches the vicinity of the wall of the vessel is preferable. It is preferred to provide a scraping blade for renewing a liquid film on the wall of the vessel. The vessel may be equipped with measuring instrument(s) such as a pressure gauge and a thermometer. The individual components are dissolved in the solvent within the vessel. The dope thus prepared is cooled and then taken out from the vessel, or is taken out from the vessel and then cooled by using a heat exchanger, etc.

The solution can also be prepared by a cooling dissolution method. According to the cooling dissolution method, it is possible to dissolve the polymer even in an organic solvent capable of hardly dissolving the polymer therein by a usual dissolution method. Incidentally, the cooling dissolution method has an effect for rapidly obtaining a uniform solution even by using a solvent capable of dissolving the polymer therein by a usual dissolution method. In the cooling dissolution method, first of all, the polymer is added in an organic solvent at room temperature while stirring step by step. It is preferred to adjust the amount of the polymer such that the polymer is contained in an amount of from 10 to 40% by mass (weight) in this mixture. The amount of the polymer is more preferably from 10 to 30% by mass. In addition, an arbitrary additive as described later may be added in the mixture.

Next, the mixture is cooled to from −100 to −10° C. (preferably from −80 to −10° C., more preferably from −50 to −20° C., and most preferably from −50 to −30° C.). The cooling can be carried out in, for example, a dry ice-methanol bath (at −75° C.) or a cooled diethylene glycol solution (at from −30 to −20° C.). The mixture of the polymer and the organic solvent is solidified by cooling. The cooling rate is preferably 4° C./min or more, more preferably 8° C./min or more, and most preferably 12° C./min or more. Incidentally, the cooling rate is a value obtained by dividing a difference between the temperature at the time of start of cooling and the final cooling temperature by a time for reaching the final cooling temperature from the start of cooling.

In addition, when the solid is heated to from 0 to 200° C. (preferably from 0 to 150° C., more preferably from 0 to 120° C., and most preferably from 0 to 50° C.), the polymer is dissolved in the organic solvent. The temperature elevation may be achieved by allowing it to stand at room temperature or by heating in a warm bath. The heating rate is preferably 4° C./min or more, more preferably 8° C./min or more, and most preferably 12° C./min or more. Incidentally, the heating rate is a value obtained by dividing a difference between the temperature at the time of start of heating and the final heating temperature by a time for reaching the final heating temperature from the start of heating. In this way, a uniform solution is obtained. Incidentally, in the case where dissolution is insufficient, the cooling or heating operation may be repeated. Whether or not the dissolution is sufficient can be judged only by visually observing the appearance of the solution.

In the cooling dissolution method, in order to avoid incorporation of water due to dew condensation at the time of cooling, it is desired to use a closed vessel. Furthermore, in the cooling or heating operation, when pressurization is carried out at the time of cooling or pressure reduction is carried out at the time of heating, the dissolution time can be shortened. In carrying out the pressurization or pressure reduction, it is desired to use a pressure vessel. Incidentally, in a 20% by mass (weight) solution of cellulose acetate (degree of acetylation: 60.9%, viscosity average polymerization degree: 299) dissolved in methyl acetate by the cooling dissolution method, according to the measurement by a differential scanning calorimeter (DSC), a pseudo phase transition temperature between a sol state and a gel state is present in the vicinity of 33° C., and the solution becomes in a uniform gel state at a temperature of not higher than this temperature. Accordingly, this solution must be kept at a temperature of the pseudo phase transition temperature or higher, and preferably at a temperature of (gel phase transition temperature) plus about 10° C. However, this pseudo phase transition temperature varies depending upon the degree of acetylation, viscosity-average polymerization degree and solution concentration of cellulose acetate and the organic solvent as used.

A polymer film is produced from the thus prepared polymer solution (dope) by the solvent casting method. The dope is cast on a drum or band, and the solvent is vaporized to form the film. It is preferred to adjust the concentration of the dope before casting such that the solids content is from 18 to 35%. It is preferred to finish the surface of the drum or band in a mirror state. A drying method in the solvent casting method is described in U.S. Pat. Nos. 2,336,310, 2,367,603, 2,492,078, 2,492,977, 2,492,978, 2,607,704, 2,739,069 and 2,739,070, U.K. Patents Nos. 640,731 and 736,892, JP-B-45-4554, JP-B-49-5614, JP-A-60-176834, JP-A-60-203430 and JP-A-62-115035. It is preferable to cast the dope on a drum or band having a surface temperature of 10° C. or lower. Drying on the band or drum can be carried out preferably by blowing air for 2 seconds or longer after the casting. The resulting film is stripped off from the drum or band and dried by high-temperature air whose temperature is changed successively from 100° C. to 160° C., whereby the residual solvent can be vaporized. Such a method is described in JP-B-5-17844. According to this method, the time from casting until stripping off can be shortened. In order to carry out this method, the dope must be gelled at the surface temperature of the drum or band at the time of casting.

To improve the mechanical properties or elevate the drying rate, the polymer film can contain a plasticizer. As the plasticizer, use may be made of a phosphoric acid ester or a carboxylic acid ester. Specific examples thereof include compounds cited in detail in Japan Institute of Invention and Innovation Journal of Technical Disclosure No. 2001-1745 (2001 Mar. 15, Japan. Institute of Invention and Innovation), p. 16. The amount of the plasticizer ranges preferably form 0.1 to 25% by mass (weight), more preferably from 1 to 20% by mass and most preferably from 3 to 15% by mass based on the amount of the cellulose ester.

Furthermore, the polymer film of the invention may various additives (for example, an ultraviolet light blocker, fine particles, a releasing agent, an antistatic agent, a degradation preventing agent (for example, an antioxidant, a peroxide decomposing agent, a radical inhibitor, a metal inactivating agent, an acid scavenger, and an amine), an infrared absorber, etc.) suitable for the purpose. These additives may be in the form of a solid or an oil. In the case where the film is composed multiple layers, individual layers may contain different additives in different amounts. As these additives, it is preferable to employ materials that are described in detail in Japan Institute of Invention and Innovation Journal of Technical Disclosure No. 2001-1745 (2001 Mar. 15, Japan Institute of Invention and Innovation), pages 17 to 22. Although each of these additives may be used in an arbitrary amount without restriction so long as it can exerts the function, the addition level thereof is preferably from 0.001 to 20% by mass (weight) in the whole polymer film composition.

The retardation of the polymer film can be further adjusted by stretching. The stretching rate is preferably from 3 to 100%. The polymer film thickness preferably ranges from 30 to 200 μm, more preferably from 40 to 120 μm.

(Alkali Saponification)

A polymer film of the invention is subjected to the alkali saponification treatment which comprises the step of preliminarily heating the film to room temperature or higher, the step of coating the film with an alkali solution, the step of maintaining the polymer film temperature at room temperature or higher, and the step of washing away the alkali solution from the polymer film. It is preferable to perform these steps and steps before and after of the same while transporting the polymer film.

(Alkali Solution)

Next, an alkali solution to be supplied in the alkali saponification treatment will be illustrated. An alkali solution of the invention can be prepared by dissolving an alkali in a solvent mixture comprising an organic solvent with water. As the organic solvent, it is preferable to use one or more organic solvents selected from among alcohols having 8 or less carbon atoms, ketones having 6 or less carbon atoms, esters having 6 or less carbon atoms and polyhydric alcohols having 6 or less carbon atoms.

(Organic Solvent)

Organic solvents are illustrated in Shinpan Yozai Poketto Bukku (Ohmsha, 1994). Specific examples of the organic solvent include monohydric alcohols (for example, methanol, ethanol, n-propanol, isopropanol, n-butanol, isobutanol, 2-butanol, cyclohexanol, benzyl alcohol, fluorinated alcohols, etc.), ketones (for example, acetone, methyl ethyl ketone, methyl isobutyl ketone, etc.), esters (for example, methyl acetate, ethyl acetate, butyl acetate, etc.), polyhydric alcohols (for example, ethylene glycol, diethylene glycol, propylene glycol, glycerol, etc.), amides (for example, N,N-dimethylformamide, dimethylfomamide), sulfoxides (for example, dimethyl sulfoxide) and ethers (for example, methyl cellosolve, ethylene glycol diethyl ether). Particularly preferable examples thereof include methanol (65° C.), ethanol (78° C.), n-propanol (97° C.), isopropanol (82° C.), n-butanol (117° C.), isobutanol (108° C.), 2-butanol (99° C.), acetone (56° C.), methyl ethyl ketone (80° C.), methyl isobutyl ketone (117° C.), methyl acetate (56° C.), ethyl acetate (77° C.), ethylene glycol (198° C.), diethylene glycol (245° C.), propylene glycol (188° C.) and glycerol (154° C.). (The bracketed values represent each the boiling point. The expression “a high-boiling solvent” as used herein means a solvent having a boiling point of 100° C. or higher, while the expression “a low-boiling solvent” as used herein means a solvent having a boiling point of lower than 100° C.)

The organic solvent should not cause the dissolution or swelling of the polymer film. To facilitate the coating with the alkali saponification solution, it is desirable to select an organic solvent having an appropriately low surface tension, as will be discussed regarding the liquid properties of the alkali solution hereinafter. The amount of the organic solvent to be used is determined depending on the solvent type, the miscibility (solubility) in water, the reaction temperature and the reaction time. To complete the saponification reaction within a short period of time, it is preferred to prepare a solution at a high concentration. In the case where the solvent concentration is too high, however, there arises the extraction of some components (plasticizer, etc.) in the polymer film or the excessive swelling of the film. Thus, the concentration should be appropriately determined. The mixing ratio by mass (weight) of the water to the organic solvent preferably ranges from 1/99 to 50/50, more preferably from 2/98 to 20/80 and more preferably from 3/97 to 10/90. So long as the mixing ratio falls within this range, the whole film face can be easily and evenly saponified without damaging the optical characteristics of the film.

(Alkali Agent)

As the alkali agent in the alkali solution, either an inorganic base or an organic base may be employed. To induce the saponification reaction at a low concentration, it is preferred to use a strong base. Preferable examples thereof include alkali metal hydroxides (for example, NaOH, KOH, LiOH), amines (for example, perfluorotributylamine, triethylamine, diazabicyclononene, diazabicycloundecene, etc.), tetraalkylammonium hydroxides (examples of the alkyl group being methyl, ethyl, propyl, butyl, etc.) and complex salt free bases (for example, (Pt(NH₃)₆)(OH₄)). Alkali metal hydroxides are more preferable and NaOH and KOH are most preferred.

The concentration of the alkali solution is determined depending on the type of the alkali employed, the reaction temperature and the reaction time. To complete the saponification reaction within a short period of time, it is preferred to prepare a solution having a high concentration. In the case where the alkali concentration is too high, however, the stability of the alkali solution is lowered and deposition arises in some cases over prolonged coating. Thus, the concentration of the alkali solution preferably ranges from 0.01 to 5 normality (N) (i.e., mol/l), more preferably from 0.02 to 3N (mol/l) and most preferably from 0.05 to 1 N (mol/l).

An alkali solution having a high concentration would absorb CO₂ in the environmental atmosphere and the absorbed CO₂ turns into carbonic acid in the solution to thereby lower the pH and cause the formation of a carbonate precipitate. Therefore, it is preferable that the CO₂ concentration in the environmental atmosphere is not more than 5000 ppm. To inhibit the absorption of CO₂ in the environmental atmosphere, it is favorable to employ a coater having a semi-sealed structure or cover the coater with dry air, an inert gas or saturated vapor of the organic solvent used in the alkali solution.

(Surfactant)

An alkali solution of the invention may contain a surfactant. Owing to the addition of the surfactant, a component of the film having been extracted with the organic solvent, if any, remains in a stable state in the alkali solution and thus the extracted component would not separate out or solidify in the subsequent water-washing step. The concentration of the surfactant is adjusted to such a level as allowing the stable dispersion of a hydrophobic additive having been extracted from the polymer film into the alkali solution. In the case where the organic solvent used in the alkali solution causes neither dissolution nor swelling of the polymer film, such an additive extracted from the film is present exclusively around the film surface. It is estimated the amount of the hydrophobic additive thus extracted is 1% by mass (weight) at the largest based on the alkali solution used in the coating amount of from 1 to 50 cc/m² in the invention. Thus, it is found out that the addition of the surfactant in an amount 10 times as much (i.e., 10% by mass (weight)) contributes to the achievement of sufficient dispersion characteristics. On the other hand, some surfactants would not be sufficiently washed away in the water-washing step but remain in the polymer film, thereby causing some troubles in the bonding (adhesion) of the film to an orientation film in the step of forming the orientation film on the polymer film. Moreover, such remaining surfactants sometimes interfere the orientation of liquid crystal molecules in the step of coating the liquid crystal molecules. Thus, it is undesirable to add a surfactant in excess. It is preferable to add the surfactant in an amount of from 0.01 to 10% by mass (weight), more preferably from 0.05 to 5% by mass. The surfactant preferably used in the alkali saponification method of the invention is not particularly restricted, so long as it is soluble or dispersible in the alkali saponification solution. Namely, use may be preferably made of either a nonionic surfactant or an ionic surfactant (an anionic, cationic or amphoteric surfactant). Among surfactants, it is preferable from the viewpoints of solubility and saponification performance to use a nonionic surfactant or an anionic surfactant.

Use may be made of either one of these surfactants, a combination of anionic surfactants or nonionic surfactants of two or more types, or a combination of an anionic surfactant with a nonionic surfactant.

Now, surfactants usable in an exemplary embodiment of the invention will be illustrated one by one.

(Nonionic Surfactant)

Examples of nonionic surfactants include polyoxyethylene alkyl ethers, polyoxyethylene alkyl phenyl ethers, polyoxyethylene polystyryl phenyl ethers, polyoxyethylene polyoxypropylene alkyl ethers, glycerol fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyethylene glycol fatty acid esters, polyglycerol fatty acid partial esters, polyoxyethylenic castor oil, polyoxyethylene glycerol fatty acid partial esters, fatty acid diethanolamides, N,N-bis-2-hydroxyalkylamines, polyoxyethylene alkylamines, triethanolamine fatty acid esters, trialkylamine oxides and so on.

As examples of preferable nonionic surfactants, compounds represented by the following formula (1) may be cited.
R¹-L¹-Q¹ Formula (1)

In the above formula, R¹ represents a linear or branched alkyl group having 8 or more carbon atoms (optionally having a substituent), preferably an alkyl group having from 8 to 22 carbon atoms and particularly preferably an alkyl group having from 10 to 18 carbon atoms. The alkyl group may have an appropriate substituent. Examples of the substituent include halogen atoms, aryl groups, heterocyclic groups, alkoxyl groups, aryloxy groups, alkylthio groups, arylthio groups, acyl groups, hydroxyl group, acyloxy groups, amino group, alkoxycarbonyl groups, acylamino groups, oxycarbonyl group, carbamoyl group, sulfonyl group, sulfamoyl group, sufonamido group, sulforyl group, carboxyl group and so on. L¹ represents a linking group linking R¹ and Q¹ which is a direct bond or a divalent liking group. It is preferable that L¹ is a single bond, —O—, —CO—, —NR¹¹—, —S—, —SO₂—, —PO(OR¹²)—, an alkylene group, an arylene group or a divalent linking group forming by combining the same. R¹¹ represents a hydrogen atom, an alkyl group, an aryl group or an aralkyl group. R¹² represents an alkyl group, an aryl group or an aralkyl group. It is preferable that L¹ is a direct bond or contains —O—, —CO—, —NR¹¹—, —S—, —SO₂—, an alkylene group or an arylene group, more preferably contains —CO—, —O—, —NR¹¹—, an alkylene group or an arylene group. In the case where L¹ contains an alkylene group, the carbon atom number of the alkylene group is preferably from 1 to 10, more preferably from 1 to 8 and particularly preferably from 1 to 6. Particularly preferable examples of the alkylene group include methylene, ethylene, trimethylene, tetrabutylene, hexamethylene and so on. In the case where L¹ contains an arylene group, the carbon atom number of the arylene group is preferably from 6 to 24, more preferably from 6 to 18 and particularly preferably from 6 to 12. Particularly preferable examples or the arylene group include phenylene, naphthalene and so on. In the case where L¹ contains a divalent linking group obtained by combining an alkylene group with an arylene group (i.e., an aralkylene group), the carbon atom number of the aralkylene group is preferably from 7 to 34, more preferably from 7 to 26 and particularly preferably from 7 to 16. Particularly preferable examples of the aralkylene group include phenylene methylene, phenylene ethylene, methylene phenylene and so on. The groups cited as L¹ may have an appropriate substituent. Examples of the substituent are the same as those cited above as the substituents of R¹¹. Q¹ represents a nonionic hydrophilic group.

As more preferable examples, compounds represented by the following formula (21) may be cited.
R²-L²-Q² Formula (2)

In the above formula, R² and L² have the same meanings respectively as R¹ and L¹ in the formula (1); and Q² represents a nonionic hydrophilic group selected from among a polyoxyethylene unit (degree of polymerization: 5 to 150), a polyglycerol unit (degree of polymerization: 3 to 30) and a hydrophilic sugar chain unit. A polyoxyethylene unit having a degree of polymerization of from 10 to 50, a polyglycerol unit having a degree of polymerization of from 5 to 15 and a hydrophilic sugar chain unit such as glucose, arabinose, fructose, sorbitol or mannose are more preferable.

Specific examples thereof include polyethylene glycol, polyoxyethylene lauryl ether, polyoxyethylene nonyl ether, polyoxyethylene cetyl ether, polyoxyethylene allyl ether, polyoxyethylene oleyl ether, polyoxyethylene behenyl ether, polyoxyethylene polyoxypropylene cetyl ether, polyoxyethylene polyoxypropylene behenyl ether, polyoxyethylene phenyl ether, polyoxyethylene octyl phenyl ether, polyoxyethylene stearylamine, polyoxyethylene oleylamine, polyoxyethylene stearic acid amide, polyoxyethylene oleic acid amide, polyoxyethylene castor oil, polyoxyethylene ethylene abietyl ether, polyoxyethylene nonyl ether, polyoxyethylene monolaurate, polyoxyethylene monostearate, polyoxyethylene glyceryl monooleate, polyoxyethylene glyceryl monostearate, polyoxyethylene propylene glycol monostearate, oxyethylene oxypropylene block polymer, distyrenated phenol polyethylene oxide adduct, tribenylphenol polyethylene oxide adduct, octylphenol polyoxyethylene polyoxypropylene adduct, glycerol monostearate, sorbitan monolaurate, polyoxyethylene sorbitol monolaurate and so on. The mass-average (weight-average) molecular weights of these nonionic surfactants range preferably from 300 to 50000, more preferably from 500 to 5000.

(Anionic Surfactant)

Appropriate examples of anionic surfactants include fatty acid salts, abietic acid salts, hydroxyalkanesulfonic acid salts, alkanesulfonic acid salts, dialkylsulfosuccinic acid ester salts, α-olefinsulfonic acid salts, linear alkylbenzenesulfonic acid salts, branched alkylbenzenesulfonic acid salts, alkylnaphthalenesulfonic acid salts, alkylphenoxypolyoxyethyelene propylsulfonic acid salts, polyoxyethylene alkylsulfophenyl ether salts, N-methyl-N-oleyl taurine sodium salts, N-alkylsulfosuccinic acid monoamide disodium salt, petroleum sulfonic acid salts, sulfated beef tallow, sulfate salts of fatty acid alkyl esters, alkyl sulfate salts, polyoxyethylene alkyl ether sulfate salts, fatty acid monoglyceride sulfate salts, polyoxyethylene alkylphenyl ether sulfate salts, polyoxyethylene styrylphenyl ether sulfate salts, alkyl phosphate salts, polyoxyethylene alkyl ether phosphate salts, polyoxyethylene alkylphenyl ether phosphate salts, partially saponified products of styrene/maleic anhydride copolymer, partially saponified products of olefin/maleic anhydride copolymer, naphthalenesulfonic acid-formalin condensation product and so on.

As examples of preferable anionic surfactants, compounds represented by the following formula (3) may be cited.
R³-L³-Q³ Formula (3)

In the above formula, R³ represents a linear or branched alkyl group having 8 or more carbon atoms (optionally having a substituent), preferably an alkyl group having from 8 to 22 carbon atoms and particularly preferably an alkyl group having from 10 to 18 carbon atoms. The alkyl group may have an appropriate substituent. Examples of the substituent include halogen atoms, aryl groups, heterocyclic groups, alkoxyl groups, aryloxy groups, alkylthio groups, arylthio groups, acyl groups, hydroxyl group, acyloxy groups, amino group, alkoxycarbonyl groups, acylamino groups, oxycarbonyl group, carbamoyl group, sulfonyl group, sulfamoyl group, sufonamido group, sulforyl group, carboxyl group and so on. L³ represents a divalent liking group. It preferably represents a divalent linking group having a polar partial structure obtained by combining units selected from the following group.

Units: —O—, —CO—, —NR⁵— (wherein R⁵ represents an alkyl group having from 1 to 5 carbon atoms), —OH, —CH═CH— and —SO₂—.

More specifically speaking, the structure of L³ in the above formula (3) may be selected so that it contains at least one of the above-described units. It is particularly preferable that L³ has an ester group (—COO—, —OCO—), an amide group (—CONR⁵—, —NR⁵CO—), a hydroxyl group (—OH) or —CH═CH— as the polar partial structure. Q³ represents an anionic group, preferably a group represented by —COOM, —OSO₃M, —P(═O)(OR²¹)OM or —SO₃M (wherein M represents a cation and R²¹ represents an alkyl group having from 1 to 3 carbon atoms), particularly preferably —SO₃M. M represents a counter cation to the anionic group and preferable examples thereof include hydrogen ion, alkali metal ions (lithium, sodium, potassium and so on) and ammonium ion. Sodium ion, potassium ion and ammonium ion are particularly preferable therefor.

(Cationic Surfactant)

Examples of cationic surfactants include alkylamine salts, quaternary ammonium salts such as tetrabutylammonium bromide, polyoxyethylene alkylamine salts, polyethylene polyamine derivatives and so on.

(Amphoteric Surfactant)

Examples of amphoteric surfactants include carboxybetaines, alkylaminocarboxylic acids, sulfobetaines, amino sulfate esters, imidazolines and so on.

In the surfactants as cited above, the term “polyoxyethylene” is replaceable by a polyoxyalkylene such as polyoxymethylene, polyoxypropylene or polyoxybutylene and these substances also fall within the category of the surfactants as described above. It is possible to use a single surfactant selected from those cited above. Alternatively, use may be made of a combination of two or more thereof, so long as the effects are not worsened by the combined use. Furthermore, such a surfactant may be used together with a fluorinated surfactant having a perfluoroalkyl group in its molecule. Examples thereof include anionic ones such as perfluoroalkylcarboxylic acid salts, perfluoroalkylsulfonic acid salts and perfluoroaklyl phosphates, amphoteric ones such as perfluoroalkylbetaines, cationic ones such as perfluoroalkyltrimethylammonium salts, and nonionic ones such as perfluoroaklylamine oxides, perfluoroalkyl ethylene oxide adducts, oligomers having a perfluoroalkyl group and a hydrophilic group, oligomers having a perfluoroalkyl group and a lipophilic group, oligomers having a perfluoroalkyl group, a hydrophilic group and a lipophilic group and urethanes having a perfluoroalkyl group and a lipophilic group, and so on.

It is also preferable that the aqueous alkali solution contains a nonionic surfactant together with an anionic surfactant or a nonionic surfactant together with a cationic surfactant to thereby enhance the advantages of the invention.

The amount of such a surfactant to be added to the alkali solution preferably ranges from 0.001 to 20% by mass (weight), more preferably from 0.01 to 10% by mass and particularly preferably form 0.03 to 3% by mass. In the case where it is added in an amount less than 0.001% by mass, the effects of the addition of the surfactant can be hardly achieved. In the case the amount exceeds 20% by mass, the saponification properties are likely worsened.

(Defoaming Agent)

Moreover, it is preferable that the alkali solution in the invention contains a defoaming agent. This additive may be added to the aqueous alkali solution preferably in an amount of from 0.001 to 5% by mass (weight), particularly preferably from 0.05 to 3% by mass. So long as the content thereof falls within this range, the saponification with the alkali treatment can evenly and uniformly proceed while avoiding the adhesion of fine bubbles to the film surface. It is particularly efficacious in quickly and continuously treating a long film of rolled type.

Examples of the defoaming agent include oils such as castor oil and linseed oil, fatty acids such as stearic acid and oleic acid, fatty acid ester such as natural wax, alcohols such as polyoxyalkylene monohydric alcohols, ethers such as di-t-amylphenoxy ethanol, heptyl cellosolve, nonyl cellosolve and 3-heptyl carbitol, phosphoric acid esters such as tributyl phosphate and tris(butoxyethyl)phosphate, amines such as diamylamine, amides such as polyalkylene amides and acylate polyamides, metal soaps such as aluminum stearate, calcium stearate, potassium oleate and wool oleic acid calcium salt, sulfuric acid esters such as sodium lauryl sulfate, and silicone-based defoaming agents such as silicone oils such as dimethyl polysiloxane, methylphenyl polysiloxane, methyl hydrogen polysiloxane, fluoropolysiloxane, dimethyl polysiloxane/polyalkylene oxide copolymers, and silicone oils of the solution type, emulsion type and paste type.

The alkali solution to be used in the invention may contain an organic solvent, other than the organic solvent as discussed above, as a dissolution aid for the surfactant or the defoaming agent in the alkali solution. The solvent is not particularly restricted, so long as it is preferably soluble in water. Examples thereof include N-phenylethanolamine, N-phenyldiethanolamine, fluorinated alcohols (for example, CₙF₂ₙ₊₁(CH₂)ₖOH (wherein n is an integer of 3 to 8 and k is an integer of 1 or 2), 1,2,2,3,3-heptafluoropropanol, hexafluorobutanediol, perfluorocyclohexanol, etc.) and so on. The content of this organic solvent is preferably form 0.1 to 5% based on the total mass (weight) of the employed liquids.

(Fungicide/Bactericide)

Furthermore, it is preferable that the alkali solution to be used invention contains a fungicide and/or a bactericide. The fungicide and bactericide to be used in the invention may be arbitrary ones, so long as the alkali saponification is not undesirably affected thereby. More specifically speaking, use can be made of bactericides described in L. E. West, Water Quality Criteria, Phot. Sci. and Eng., Vol. 9, No. 6 (1965), fungicides described in JP-A-57-8542, JP-A-58-105415, JP-A-59-126533, JP-A-55-111942 and JP-A-57-157244 and chemicals described in Hiroshi Horiguchi, Bokin Bobi no Kagaku, Sankyo Shuppan (1982), Nippon Nokin Bobi Gakkai, Bokin Bobi Gijutsu Hando Bukku, Gihodo (1986). The content of such a fungicide and/or bactericide is preferably from 0.01 to 50 g/L in the aqueous alkali solution, more preferably from 0.05 to 20 g/L.

(Other Additives)

The alkali solution to be used in the invention may further contain other additives. Examples thereof include an alkali solution stabilizer (an antioxidant, etc.) and a water-soluble compound (polyalkylene glycols, natural water-soluble resins, etc.). The additives to be used in the alkali solution of the invention are not restricted thereto.

(Water)

As the water to be used in the alkali solution, use is preferably made of water fulfilling the requirements relating to effects of individual elements and minerals contained in water and so on in accordance with The Japanese Water Supply Law (Law No. 177, 1962) and The Ministry Ordinance relating to water qualities based thereon (Ordinance No. 56 of Ministry of Health and Welfare, Aug. 31, 1978), The Japanese Hot Spring Law (Law No. 125, Jul. 10, 1948 and attached sheet), and Standards for Water Supply defined by WHO.

To further ensure the achievement of the advantages of the invention, it is preferable to employ the water as described above. The calcium concentration of the alkali solution preferably ranges from 0.001 to 400 mg/L, more preferably 0.001 to 150 mg/L and particularly preferably from 0.001 to 10 mg/L. The magnesium concentration preferably ranges from 0.001 to 400 mg/L, more preferably from 0.001 to 150 mg/L and particularly preferably from 0.001 to 10 mg/L. It is also preferred that the solution contains polyvalent metal ions other than the calcium and magnesium ions. The concentration of the polyvalent metal ion preferably ranges from 0.002 to 1000 mg/L. On the other hand, it is preferable that the alkali solution is free from anions such as chloride ion or carbonate ion. The chloride ion concentration is preferably from 0.001 to 500 mg/L, more preferably from 0.001 to 300 mg/L and particularly preferably from 0.001 to 100 mg/L. It is also preferable that the alkali solution is free from carbonate ion. The carbonate ion concentration is preferably from 0.001 to 3500 mg/L, more preferably from 0.001 to 1000 mg/L and particularly preferably from 0.001 to 200 mg/L. Within these ranges, the formation of insoluble matters in the solution can be prevented.

(Liquid Properties of Alkali Solution)

It is preferable that the alkali solution to be employed in the invention, which has the composition as discussed above, is controlled so as to achieve liquid properties of the following ranges. Namely, it is preferable that the surface tension of the alkali saponification solution is not more than 45 mN/m and the viscosity thereof is from 0.8 to 20 mPas. It is more preferable that its surface tension is from 20 to 40 45 mN/m and the viscosity thereof is from 1 to 15 mPas. Within these ranges, stable coating with the alkali solution can be easily performed depending on the transporting speed and the wettability with the liquid to the film surface, the retention of the liquid having been applied to the film surface and removal of the alkali solution from the film surface after the completion of the saponification can be sufficiently conducted. It is also preferable that the density of the alkali solution is from 0.65 to 1.05 g/cm³, more preferably from 0.70 to 1.00 g/cm³, and more preferably from 0.75 to 0.95 g/cm³. Within this viscosity range, the saponification can be evenly conducted without causing blowing-induced unevenness due to the blowing pressure during transportation, the formation of a cord parallel to the transporting direction due to the own weight of the film, etc. Furthermore, it is preferable that the electric conductivity of the alkali solution of the invention is from 1 mS/cm to 100 mS/cm, more preferably from 2 mS/cm to 50 mS/cm and particularly preferably from 3 mD/cm to 50 mS/cm. Within this electric conductivity range, the saponification can evenly proceed and the saponification solution can be easily removed from the film surface after the completion of the saponification. It is undesirable that the electric conductivity is less than 1 mS/cm, since impurities remaining on the saponified film surface would frequently cause luminescent spot failures or the optically anisotropic layer would frequently undergo adhesion failure in this case. Concerning the liquid properties of the alkali saponification solution, it is also preferable that the absorbance of the liquid at a measurement wavelength of 400 nm is less than 2.0.

(Method of Alkali Saponification Treatment)

According to a saponification treatment of an exemplary embodiment of the invention, the alkali saponification treatment is conducted via the step of preliminarily heating a polymer film at room temperature or higher (if necessary), the step of coating the polymer film with an alkali solution, the step of maintaining the temperature of the polymer film at room temperature or higher (if necessary), and the step of washing away the alkali solution from the polymer film. Before the step of preliminarily heating the polymer film at room temperature or higher or the step of coating the polymer film with an alkali solution, it is also possible to perform a treatment of removing electricity, a treatment of removing dust or a wetting treatment so as to remove dust and debris and elevate the wettability on the film surface. These treatments can be performed by using commonly known methods. Namely, electricity can be removed by a method described in JP-A-62-131500 while dust and debris can be removed by a method described in JP-A-2-43157. In the step of preliminarily heating the polymer film at room temperature or higher, it is preferable to use the collision of a warm/hot air stream, contact heat transfer with the use of a heat roll, inductive heating with the use of microwave, radiation heating with the use of an infra-red heater, and so on. In particular, contact heat transfer with the use of a heat roll is preferred, since it can achieve a high heat transfer efficiency while needing only a small setting area and the film temperature can quickly rise at the initiation of transportation. Use can be made therefor of a commonly employed double-jacket roll or an electromagnetic conductive roll (manufactured by TOKUDEN). After heating, the surface temperature of the film is preferably form 15 to 150° C., more preferably from 25 to 100° C. and most preferably from 30 to 80° C.

In the step of coating the polymer film with the alkali solution, use can be preferably made of a die coater (an extrusion coater, a slide coater), a roll coater (a forward roll coater, a reverse roll coater, a gravure coater) or a rod coater (a rod having a thin metal wire wound around). Coating modes are reported in various documents (for example, Edward Cohen and Edger B. Gutoff, Edits., Modern Coating and Drying Technology, VCH Publishers Inc., 1992). By considering the treatment of the waste liquor formed by the subsequent water washing removal, it is preferable to minimize the coating amount of the alkali solution. It preferably ranges from 1 to 100 cc/m², more preferably form 1 to 50 cc/m². It is particularly preferable to use a rod coater, a gravure coater, a blade coater or a die coater which can be safely handled even in a small coating amount range. To easily wash away the alkali solution form the polymer film after coating the alkali solution and saponifying the polymer film, it is favorable to apply the alkali solution to the bottom face of the polymer film. Also, it is preferred to control a variation in the coating amount to less than 30% regarding the width direction of the polymer film and the coating time. It is also possible to employ the continuous coating system. In the invention, it is preferable to saponify the polymer film in an atmosphere with an oxygen concentration of from 0 to 18%, more preferably 0 to 15% and most preferably form 0 to 10%. By coating the saponification coating solution (the alkali solution) at a low oxygen concentration, the surface characteristics of the film can be controlled and a highly adhesive surface can be obtained. It is preferable that the atmosphere contains inert gases (for example, nitrogen, helium or argon) as gas components other than oxygen and nitrogen is particularly preferred.

Concerning the alkali coating amount required for the saponification reaction, the total saponification site count (i.e., the theoretical alkali coating amount), which is determined by multiplying the saponification site count per unit area of the polymer film by the saponification depth required for ensuring close adhesion to the orientation film, is usable as an indication. As the saponification reaction proceeds, the alkali is consumed and thus the reaction speed is lowered. Therefore, it is preferable in practice to apply the alkali solution in an amount several times more than the theoretical alkali coating amount as defined above. More specifically speaking, the coating amount in practice is preferably 2 to 20 times, more preferably 2 to 5 times, more than the theoretical alkali coating amount.

It is preferable that the temperature of the alkali solution is the same as the reaction temperature (i.e., the temperature of the polymer film). The reaction temperature sometimes exceeds the boiling point of the alkali solution depending on the organic solvent employed. To safely conduct the coating, it is preferable that the reaction temperature is lower than the boiling point of the alkali solution. It is more preferable that the reaction temperature is lower by 5° C., most preferably by 10° C., than the boiling point.

In the alkali saponification method of the invention, the polymer film having been coated with the alkali solution is maintained at room temperature or higher until the completion of the saponification reaction. The term “room temperature” as used herein means 15° C. The heating means is appropriately selected considering that one face of the polymer film is wet from the alkali solution. That is, use may be preferably made of collision of a hot air stream to the face opposite to the coated face, contact heat transfer using a heat roll, inductive heating with microwave, radiation heating with an infra-red heater, etc. It is preferable to use an infra-red heater, since it enables non-contact heating without causing air stream and thus the effects on the face coated with the alkali solution can be minimized thereby. As an infra-red heater, use can be made of a far-infrared heater of the electric type, gas type, oil type or steam type. It is also possible to use a marketed infra-red heater (for example, a product of NORITAKE COMPANY LIMITED). It is preferable from the viewpoint of preventing explosion in an atmosphere having an organic solvent present together to use an infra-red heater of oil or steam type using an oil or a steam as a heat medium. The polymer film temperature may be either the same as or different from the heating temperature before the coating with the alkali solution. The temperature may be continuously or stepwise varied in the course of the saponification. The film temperature ranges from 15° C. to 150° C., preferably from 25° C. to 100° C. and more preferably form 30° C. to 80° C. The film temperature may be measured by using a commonly marketed non-contact infra-red thermometer. To control the film temperature within the range as described above, the heating means may be feedback regulated.

The time of holding the temperature within the above-described range from coating of the alkali solution to washing away the same is preferably from 1 second to 5 minutes, more preferably from 2 to 100 seconds and particularly preferably from 3 to 50 seconds, though it varies depending on the transportation speed as will be discussed hereinafter.

It is preferable to conduct individual steps while transporting the polymer film to thereby complete the alkali saponification. The speed of transporting the polymer film is determined depending on the combination of the composition of the alkali solution with the coating mode. In general, the transportation speed preferably ranges from 10 to 500 m/min, more preferably from 20 to 300 m/min.

Concerning the liquid properties of the alkali saponification solution, it is also preferable that the absorbance of the liquid at a measurement wavelength of 400 nm is less than 2.0. Thus, it is required to determine the sizes of the liquid transportation system and the coater so that the absorbance of the liquid is not elevated due to the extraction of additives in the polymer film in the course of the coating. In the case of using a liquid having a high absorbance, additives in the polymer film is eluted into the solution and adhere on the polymer film, thereby causing luminescent spot failure. The absorbance of the alkali saponification solution can be controlled by using a method whereby eluted components are adsorbed and removed with the use of active carbon. The active carbon is not restricted in the form, material, etc. so long as it has the function of removing coloring components in the saponification solution. The active carbon may be directly put into a liquid tank. Alternatively, the saponification solution may be circulated through a saponification solution tank and a purifier tank packed with the active carbon.

Methods of ceasing the saponification reaction between the alkali solution and the polymer film may be roughly classified into three types. The first method comprises diluting the alkali solution to lower the alkali concentration and thus lowering the reaction speed. The second method comprises lowering the temperature of the polymer film coated with the alkali solution and thus lowering the reaction speed. The third method comprises neutralizing with an acidic liquid.

To dilute the applied alkali solution, use can be made of a method of coating a dilution solvent, a method of spraying a dilution solvent or a method of dipping the polymer film in a vessel containing a dilution solvent. The method of coating a dilution solvent and the method of spraying a dilution solvent are favorable for conducting the procedure while continuously transporting the polymer film. The method of coating a dilution solvent is most preferable, since it can be performed while minimizing the required amount of the dilution solvent.

It is desirable that the dilution solvent is applied in a manner allowing continuous application so that the dilution solvent can be applied again onto the polymer film having been coated with the alkali solution. In the coating, it is preferred to use a die coater (an extrusion coater, a slide coater), a roll coater (a forward roll coater, a reverse roll coater, a gravure coater) or a rod coater, as mentioned above regarding the step of coating the alkali solution. To quickly mix the alkali solution with the dilution solvent to thereby lower the alkali concentration, a roll coater or a rod coater, whereby an uneven flow can be formed, is preferred to a die coater whereby a layered flow is formed in a minor area to which the dilution solvent is to be applied (sometimes being called a coating bead).

Since the dilution solvent is to be used for lowering the alkali concentration, the alkali agent in the alkali solution should be soluble therein. Accordingly, it is preferable to use water or a mixture of an organic solvent with water. Use may be made of a mixture of two or more organic solvents. The organic solvents cited above employed in the alkali saponification solution can be favorably used. A preferred solvent is water.

The coating amount of the dilution solvent is determined depending on the concentration of the alkali solution. In the case of using a die coater forming a layered flow in the coating bead, the coating amount is preferably at such a level as diluting 1.5- to 10-fold the original alkali concentration. It is more preferable to dilute 2- to 5-fold. In the case of using a roll coater or a rod coater, the flow in the coating bead is not even and thus the alkali solution is mixed with the dilution solvent. Then the thus mixed liquid is applied again. In this case, therefore, the dilution ratio cannot be specified depending on the coating amount of the dilution solvent. Thus, the alkali concentration should be measured after the application of the dilution solvent. In the case of using a roll coater or a rod coater, it is also preferable to dilute 1.5- to 10-fold the original alkali concentration. It is more preferable to dilute 2- to 5-fold.

To quickly cease the saponification reaction with the alkali, it is also possible to use an acid. To neutralize with an acid in a small amount, it is preferred to use a strong acid by considering the easiness in washing with water, it is preferred to select an acid capable of forming a salt having a high solubility in water after the neutralization reaction with the alkali. Hydrochloric acid, nitric acid, sulfuric acid, phosphoric acid, chromic acid, methanesulfonic acid and citric acid are particularly preferred.

To neutralize the alkali solution having been applied with an acid, use can be made of a method of coating an acid solution, a method of spraying an acid solution or a method of dipping the polymer film in a vessel containing an acid solution. The method of coating an acid solution and the method of spraying an acid solution are favorable for conducting the procedure while continuously transporting the polymer film. The method of coating an acid solution is most preferable, since it can be performed while minimizing the required amount of the acid solution.

It is desirable that the acid solution is applied in a manner allowing continuous application so that the acid solution can be applied again onto the polymer film having been coated with the alkali solution. In the coating, it is preferred to use a die coater (an extrusion coater, a slide coater), a roll coater (a forward roll coater, a reverse roll coater, a gravure coater) or a rod coater (a rod having a thin metal wire wound around) as mentioned above regarding the step of coating the alkali solution. To quickly mix the alkali solution with the acid solution to thereby lower the alkali concentration, a roll coater or a rod coater, whereby an uneven flow can be formed, is preferred to a die coater whereby a layered flow is formed in a minor area to which the acid solution is to be applied (sometimes being called a coating bead).

The coating amount of the acid solution is determined depending on the type of the alkali and the concentration of the alkali solution. In the case of using a die coater forming a layered flow in the coating bead, the coating amount of the acid solution is preferably 0.1 to 5 times, more preferably 0.5 to 2 times, as much as the original alkali. In the case of using a roll coater or a rod coater, the flow in the coating bead is not even and thus the alkali solution is mixed with the acid solution. Then the thus mixed liquid is applied again. In this case, therefore, the neutralization ratio cannot be specified depending on the coating amount of the acid solution. Thus, the alkali concentration should be measured after the application of the acid solution. In the case of using a roll coater or a rod coater, it is also preferable to determine the coating amount of the acid solution so as to adjust the pH value to 4 to 9, more preferably 6 to 8, after the application of the acid solution.

It is also possible to cease the saponification reaction by lowering the temperature of the polymer film. Namely, the saponification reaction is substantially ceased by sufficiently lowering the temperature from the state maintained at room temperature or higher so as to promote the reaction. The means of lowering the temperature of the polymer film is determined while taking the fact that one face of the polymer film is wet into consideration. Namely, it is favorable to employ collision of a cold air stream to the face opposite to the coated face or contact heat transfer with the use of a cooling roll. After the cooling, the temperature of the polymer film is preferably from 5° C. to 60° C., more preferably form 10° C. to 50° C. and most preferably from 15° C. to 30° C. The film temperature may be measured by using a non-contact infra-red thermometer. To control the cooling temperature, the cooling means may be feedback regulated.

The washing step is carried out to remove the alkali solution. In the case where the alkali solution remains, the saponification reaction proceeds and, furthermore, the subsequent film formation of the orientation film and the liquid crystal molecule layer and the orientation of liquid crystal molecules are affected. The washing can be conducted by a method of coating washing water, a method of spraying washing water or a method of dipping the polymer film in a vessel containing washing water. The method of coating washing water and the method of spraying washing water are favorable for conducting the procedure while continuously transporting the polymer film. The method of spraying washing water is particularly preferable, since the washing water and the alkaline coating solution can be turbulently mixed on the polymer film owing to the jet flow.

The method of spraying washing water can be carried out by a method of using a coating head (for example, a fountain coater, a flog mouth coater) or a method of using a spray nozzle employed in humidifying the atmosphere, painting and automatically washing a tank. Coating modes are reported in Koteing no Subete, ed. by Masayoshi Araki, Kako Gijutsu Kyokai K.K. (1999). By aligning conical or fan-shaped spray nozzles in the width direction of the polymer film, collision of water streams can be made over to the whole film width. Use may be made of a marketed spray nozzle (for example, products manufactured by Ikeuchi K.K. or Spraying Systems).

The stronger turblent mixing can be conducted at a higher water spraying speed. In the case where the speed is excessively high, however, the transportation stability of the polymer film under continuous transportation is sometimes worsened. Thus, the spraying collision speed is preferably from 50 to 1000 cm/sec, more preferably from 100 to 700 cm/sec and most preferably from 100 to 500 cm/sec.

The amount of the water to be used in the water-washing is at a level exceeding the theoretical dilution ratio as defined above.
Theoretical dilution ratio=amount of water used in washing (cc/m²)/coating amount of alkali saponification solution (cc/m²)

That is to say, the theoretical dilution ratio is determined on the assumption that all of the water employed in the water-washing contributes to the mixing/dilution of the alkaline coating solution. In practice, however, complete mixing would not occur and, therefore, it is needed to use the washing water in an amount exceeding the theoretical dilution ratio. The washing water is used in an amount at least 100 to 1000 times, preferably 500 to 10,000 times and more preferably 1,000 to 100,000 times as much as the theoretical level, though it varies depending on the alkali concentration of the alkaline coating solution employed, secondary additives, the solvent type and so on.

It is preferable to regulate the variation in the amount of the sprayed water within 30% regarding the width direction of the polymer film and the coating time. At the both ends of the polymer film, however, it is frequently observed that the alkali solution or the acid solution for neutralization is used in a large coating amount. To ensure sufficient washing performance in such parts with large coating amount, therefore, it is possible to spray water in an increased amount in the width direction at both ends. In the case of using a coating head, the clearance of a water-jetting slit is made broader so as to increase the flow rate at both ends. Alternatively, it is possible to provide a coater with a narrow width for topically supplying water films to both ends. A plural number of such coaters with a narrow width may be provided. In the case of using a spray nozzle, nozzles for topically spraying water to ends are provided.

In the case of using water in a definite amount in the water-washing, a batch type washing method of supplying water in several portions is preferred to a method of supplying the total volume of water at once. Namely, water is divided in several portions and supplied to a plural number of washing means located in tandem in the transportation direction of the polymer film. These washing means are located at an appropriate interval of time (distance) so that the dilution with the alkaline coating solution proceeds due to diffusion. It is more preferable to transport the polymer film at an angle so as to allow water to flow on the film face. Thus, mixing dilution due to flowing, in addition to the diffusion, can be made. In the most preferable method, a draining means of removing a water film on the polymer film is provided between a washing means and the next washing means so as to further elevate the water-washing and dilution efficiency. Specific examples of the draining means include a blade used in a blade coater, an air knife used in an air knife coater, a rod used in a rod coater and a roll used in a roll coater. It is more advantageous to provide a larger number of water-washing means located in tandem. From the viewpoints of setting space and setting costs, use is usually made of from 2 to 10 water-washing means, preferably from 2 to 5 water-washing means.

After the completion of the draining, a thinner water film is preferred. However, the minimum water film thickness is restricted depending on the type of the draining means employed. In a method of mechanically contacting the polymer film with a solid substance such as a blade, a rod or a roll, even though the solid is made of an elastic material having a low hardness such as rubber, the film surface would be injured or the elastic matter would be rubbed off. It is therefore necessary to leave the water film in a limited amount as a lubricating fluid. In usual, a water film of several μm or more, preferably 10 μm or more is left as a lubricating fluid.

As a draining means for minimizing the water film thickness, an air knife is preferred. By using appropriate blowing amount and blowing pressure, the water film thickness can be reduced to close to zero. When air is blown in an excessively large amount, however, there sometimes arise flapping, deviation, etc. and thus the transportation stability of the polymer film is affected. Thus, there is a preferable range of the blowing rate. Namely, the blowing rate is usually from 10 to 500 m/sec, preferably form 20 to 300 m/sec and more preferably from 30 to 200 m/sec, though it varies depending on the original water film thickness on the polymer film and the transportation speed of the film. To evenly remove the water film, the blowing port of an air knife or the method of supplying air to the air knife is controlled so that the blowing rate distribution in the width direction of the polymer film falls within a range of 10% in usual, preferably 5%. Although a narrower gap between the surface of the polymer film under transportation and the blowing port of the air knife contributes to improvement in the draining performance, there is an increasing risk in this case that the air knife comes into contact the polymer film and injures it. Namely, there is also a preferable range thereof. That is, the air knife is provided at a distance of usually from 10 μm to 10 cm, preferably from 100 μm to 5 cm and more preferably from 500 μm to 1 cm. It is also preferable to provide a backup roll in the opposite side to the water-washed face of the polymer film (i.e., facing the air knife), since the gap can be stably set and undesirable effects (flapping, wrinkling, deformation, etc.) on the film can be relieved thereby.

As the washing water, purified water may be preferably employed. It is preferred that the purified water to be used in the invention has a specific electrical resistivity of at least 0.1 MΩ, contains less than 1 ppm of metal ions such as sodium, potassium, magnesium and calcium ions and less than 0.1 ppm of anions such as chlorine and nitrate. The purified water can be obtained by using the reverse osmotic membrane method, the ion exchange resin method, the distillation method or a combination thereof.

The higher washing performance can be obtained at a higher washing water temperature. In the method wherein water is sprayed onto a polymer film under transportation, however, water comes into contact with air in a large area and thus evaporation is accelerated with an increase in temperature. As a result, the environmental temperature is elevated and the risk of dew formation is also elevated. Therefore, the washing water temperature is usually controlled to 5 to 90° C., preferably 25 to 80° C. and more preferably 25 to 60° C.

In the case where the components of the alkali saponification solution or the saponification reaction product are insoluble in water, it is also possible to add a solvent washing step for removing these water-insoluble components before or after the water washing step. In the solvent washing step, use can be made of the water washing methods and draining means as described above. As examples the organic solvent to be used herein, those usable in the alkali saponification solution as described above and solvents mentioned in Shinpan Yozai Poketto Bukku (Ohmsha, 1994) may be cited.

It is also possible to conduct a drying step after the washing step. Usually, the water film can be sufficiently removed by a draining means such as an air knife and thus no drying step is needed in some cases. However, the polymer film may be dried by heating to attain a preferable moisture content before rolling it. On the contrary, the moisture content may be controlled by using a moist air stream having a defined humidity. The temperature of the drying air stream preferably ranges from 30 to 200° C., preferably from 40 to 150° C. and particularly preferably from 50 to 120° C.

In the alkali saponification method of the invention, a functional layer may be continuously formed after the saponification step. By saponifying one face of the film by coating and then forming the functional layer thereon, the sticking of the functional face to the opposite face of the film can be prevented in rolling the film after the formation of the functional layer.

(Surface Characteristics of Cellulose Ester Film)

By saponifying the film by coating, “luminescent spot failure” and “unevenness in display” can be relieved. It is clarified that, to surely relieve “luminescent spot failure”, the surface characteristics of the saponified film should be controlled. It is also found out that, when the surface characteristics of the saponified film are not controlled, there arises luminescent spot failure and, moreover, a liquid crystal display sometimes suffers from “cloud shadow” after using over a long time even though the saponification is performed.

The term “luminescent spot failure” means star-shaped luminous spots which appear on the screen of a liquid crystal display and can be easily observed in black display. As the results of studies on the luminescent spot failure, it is found out that this phenomenon is caused by sticking of small pieces of the orientation film or the optically anisotropic layer. It is also found out that these pieces are formed since the orientation film (and the optically anisotropic layer at the same time) slightly peels from the film due to the impact in cutting (or punching) for fitting the liquid crystal display size. The term “cloud shadow” means a trouble that a cloudy shadow is formed on the screen of a liquid crystal display. It can be easily observed in white display. This cloud shadow scarcely occurs immediately after the fabrication of the liquid crystal display. Namely, it becomes obvious after using the device over a long time. As the results of studies on the cloud shadow, it is found out that the cloud shadow is caused since a low-molecular weight compound (for example, a plasticizer) contained in the optical compensation sheet migrates toward the interface of the orientation film and the optically anisotropic layer and separates out therein after prolonged use. It is furthermore found out that the cloud shadow more likely occurs in the case of performing the saponification by the coating method than in the existing saponification method by dipping.

It is found out that, when the face of a cellulose ester film having been saponified by the coating method fulfills one or more of the surface characteristics (1) to (6) as described below, the luminescent spot failure occurring in using an optical compensation sheet in a liquid crystal display can be prevented without causing the cloud shadow, in addition to the advantages (i.e., retention of a smooth film plane and so on) achieved by the saponification treatment of the coating method. Now, film surface characteristics capable of preventing “luminescent spot failure” and “cloud shadow” in the case of saponifying a cellulose ester film by the coating method will be listed hereinbelow.

(1) The saponification depth of the film surface ranges form 0.010 to 0.8 μm. It is preferable that the saponification depth is from 0.020 to 0.6 μm, more preferably from 0.040 to 0.4 μm.

(2) The ratio C═O/C—O, which indicates the ratio of chemical bonds existing on the surface, ranges from 0 to 0.6, and the ratio C—C/C—O ranges from ˜0.45 to 0.75. It is preferable that the ratio C—C/C—O is from 0 to 0.5, more preferably from 0 to 0.5. It is preferable that the ratio C═O/C—O is from 0.5 to 0.7, more preferably from 0.5 to 0.65.

(3) In the case of a cellulose film containing a phosphorus compound as a plasticizer, the ratio O/C, which indicates the ratio of elements existing on the surface, ranges from 0.62 to 0.75 and the ratio P/C ranges from 0.007 to 0.015. It is preferable that the ratio O/C on the surface is from 0.63 to 0.73, more preferably from 0.64 to 0.71. It is preferable that the ratio P/C on the surface is from 0.008 to 0.0145, more preferably from 0.009 to 0.014.

(4) In the case of using a cellulose acetate film as the cellulose ester film, the degree of acetylation of the film surface ranges from 1.8 to 2.7. It is preferable that the degree of acetylation is from 1.85 to 2.5, more preferably from 1.9 to 2.4.

(5) The contact angle with water on the film surface ranges from 20 to 55°. It is preferable that contact angle with water is from 25 to 50°, more preferably from 30 to 45°.

(6) The surface energy on the film surface preferably ranges from 55 to 75 mN/m.

Although it still remains unknown why the luminescent spot failure and the cloud shadow can be inhibited by achieving these surface characteristics, the mechanism thereof is estimated as follows. In the case where the saponification depth is too large, for example, there seemingly arises cleavage in the cellulose ester main chain and so on around the surface. Due to the cleavage in the main chain, the molecular weight of the cellulose ester on the film surface is lowered and it becomes brittle. As a result, the adhesiveness of the film to the orientation film is worsened. By the excessive saponification of the film surface (i.e., from the surface to the deep part), low-molecular weight compounds (a plasticizer, etc.) are frequently formed and adhere in a large amount to the area around the surface. After a long time, these low-molecular weight compounds separate out on the surface of the orientation film, thereby seemingly causing the cloud shadow. In the case where the saponification depth is too small, it appears that the saponification treatment achieves only insufficient effects and thus the adhesiveness of the film to the orientation film is lowered. Since the saponification depth is extremely small in this case, low-molecular weight compounds (a plasticizer, etc.) existing in a trace amount in the area highly close to the cellulose ester film surface likely separate out up to the surface of the orientation film after a long period of time.

The surface characteristics of the cellulose ester film can be controlled within the ranges as described above by controlling the conditions of the saponification treatment by coating. The largest points in controlling the surface characteristics reside in coating the cellulose ester film with the alkali solution in an atmosphere with a low oxygen concentration of 18% or less and subsequently washing away the alkali solution with a washing liquor at 30° C. to 80° C. (preferably warm water).

(Method of Evaluating Surface Characteristics)

The surface characteristics (1) to (5) of the cellulose ester film can be evaluated by methods described in WO 02/46809, pages 27 to 30. Among the surface characteristics, the surface energy (6) can be determined by the contact angle method, the wet heat method and the adsorption method described in Nure no Oyo to Kiso (REALIZE, 1989). In the case of the cellulose ester film of the invention, the contact angle method may be preferably employed. More specifically speaking, this method comprises dropping two solvents with known surface energies onto the cellulose ester film, referring the angle between the tangent to the droplets and film surface at the intersection point of the droplet surface and the film surface a to the contact angle (involving the droplet), and then calculating the surface energy of the film.

(Optical Compensation Sheet)

The saponified polymer film is preferably usable as a transparent support of an optical compensation sheet. An optical compensation sheet has a layered structure consisting of the polymer film having been saponified by coating with an alkali solution, a resin layer for forming an orientation film and an optically anisotropic layer wherein the orientation of liquid crystal molecules have been fixed in this order. The orientation film can be formed by the step of heating the polymer film, the step of coating an alkali solution to the surface of the polymer film in the orientation film side, the step of maintaining the temperature of the surface coated with the alkali solution, the step of ceasing the reaction and the step of washing away the alkali solution from the film surface, optionally followed by the step of coating the orientation film and drying. It is also possible to rub the orientation film surface after drying and apply a liquid crystal molecule layer and dry, thereby finally forming an optical compensation sheet. By consistently conducting not only the saponification of the polymer film but also the formation of the orientation film and the liquid crystal molecule layer, a high productivity can be established. Moreover, it is possible to achieve additional advantages such that the procedures from the saponification to the formation of the orientation film can be carried out without a break, the activated saponified face is little deteriorated, the water washing step after the saponification also contributes to the removal of dust and debris in the wet manner, and a loss at the roll end accompanying repeated feeding and winding can be avoided.

An optical compensation sheet comprises a transparent support made of the saponified polymer film, an orientation film formed thereon and an optically anisotropic layer having a discotic structural unit. It is preferable that the orientation film is a rubbed film made of a crosslinked polymer. As the compound having a discotic structural unit to be used in the optically anisotropic layer, use may be made of a low-molecular weight discotic liquid crystal compound (a monomer) or a polymer obtained by polymerizing a polymerizable discotic liquid crystal compound. Discotic compounds are generally divided into compounds having a discotic liquid crystal phase (i.e., a discotic nematic phase) and compounds having no discotic liquid crystal phase. A discotic compound generally has a negative birefringence. In the optically anisotropic layer, the negative birefringence of such a discotic compound is utilized.

(Orientation Film)

It is preferred to form the orientation film of the optically anisotropic layer by rubbing a film made of a crosslinked polymer. It is more preferable that the orientation film comprises two types of crosslinked polymers. One of these polymers is a polymer which is crosslinkable per se or can be crosslinked by a crosslinking agent. The orientation film can be formed by a reaction between polymer molecules of a polymer having a functional group or a polymer into which a functional group has been introduced due to light, heat or a pH change, or using a crosslinking gent which is a highly active compound and introducing a binding group originating in the crosslinking agent between the polymer molecules to thereby crosslink the polymer.

The polymer can be crosslinked by coating a coating solution containing the polymer or a mixture of the polymer with the crosslinking agent to the transparent support and then heating. The crosslinking treatment can be performed at any step from the formation of the orientation film on the transparent support to the formation of the optical compensation sheet. Considering the orientation of the compound having a discotic structure (the optically anisotropic layer) formed on the orientation film, it is preferred to carry out the final crosslinking after the orientation of the discotic compound. In the case of coating a coating solution containing the polymer and a crosslinking agent capable of inducing the crosslinking of the polymer onto the transparent support, the orientation film is formed by heat drying and rubbing and then a coating solution containing the compound having a discotic structural unit is applied on this orientation film. Then it is heated to a temperature higher than the discotic nematic phase-forming temperature and then cooled to thereby form the optically anisotropic layer.

As the polymer to be used in the orientation film, use may be made of either a polymer crosslinkable per se or a polymer which is crosslinked by using a crosslinking agent. It is also possible to use a combination of multiple polymers. Examples of the polymer include polymethyl methacrylate, acrylic acid/methacrylic acid copolymer, styrene/maleimide copolymer, polyvinyl alcohol and denatured polyvinyl alcohol, poly(N-methylolacrylamide), styrene/vinyl toluene copolymer, chlorosulfonated polyethylene, nitrocellulose, polyvinyl chloride, chloro polyolefin, polyester, polyimide, vinyl acetate/vinyl chloride copolymer, ethylene/vinyl acetate copolymer, carboxymethylcellulose, polyethylene, polypropylene and polycarbonate. It is also possible to use a silane coupling agent as a polymer. Water-soluble polymers (for example, poly(N-methylolacrylamide), carboxymethylcellulose, gelatin, polyvinyl alcohol and denatured polyvinyl alcohol) are preferable, gelatin, polyvinyl alcohol and denatured polyvinyl alcohol are more preferable, and polyvinyl alcohol and denatured polyvinyl alcohol are most preferable. It is particularly preferable to employ two types of polyvinyl alcohol of denatured polyvinyl alcohol having different polymerization degrees.

The degree of saponification of polyvinyl alcohol preferably ranges from 70 to 100%, more preferably from 80 to 100% and most preferably from 85 to 95%. The degree of polymerization of polyvinyl alcohol preferably ranges from 100 to 3000. The denaturation group of denatured polyvinyl alcohol can be introduced by chain transfer denaturation or block polymerization denaturation. Examples of the denaturation groups include hydrophilic groups (carboxylate groups, sulfonate group, phosphonate group, amino group, ammonium group, amide group, thiol group, etc.), hydrocarbon groups having from 10 to 100 carbon atoms, fluorinated hydrocarbon groups, thioether groups, polymerizable groups (unsaturated polymerizable groups, epoxy group, aziridinyl group, etc.), alkoxysilyl groups (trialkoxy, dialkoxy, monoalkoxy) and so on. Specific examples of such denatured polyvinyl alcohols include those described in, for example, JP-A-2000-155216, paragraphs (0022) to (0145) and JP-A-2002-62426, paragraphs (0018) to (0022). It is preferable to employ an aldehyde having a high reactivity, in particular, glutaraldehyde.

It is preferred to add the crosslinking agent in an amount of from 0.1 to 20% by mass (weight), more preferably form 0.5 to 15% by mass, based on the polymer. The content of the unreacted crosslinking agent remaining in the orientation film is preferably 1.0% by mass (weight) or less, more preferably 0.5% by mass or less. In the case where the orientation film contains more than 1.0% by mass of the crosslinking agent remaining therein, a sufficient durability cannot be obtained. When such an orientation film is used in a liquid crystal display, there sometimes arises reticulation over prolonged usage or prolonged storage at high temperature and humidity.

The orientation film can be fundamentally formed by coating orientation film-forming materials including the polymer and the crosslinking agent onto a transparent support, drying (crosslinking) by heating, and then rubbing. As stated above, the crosslinking reaction may be conducted at any stage after the application onto the transparent support. In the case of using a water-soluble polymer such as polyvinyl alcohol as the orientation film-forming material, it is preferable to use a solvent mixture comprising an organic solvent having a defoaming effect (for example, methanol) with water in the coating solution. The mixing ratio by mass (weight) of water:methanol is preferably from 0:100 to 99:1, more preferably from 0:100 to 91:9. Thus, foaming can be prevented and defects in the orientation film and, in its turn, defects in the optically anisotropic layer surface can be largely lessened. It is preferable to apply the orientation film by the spin coating method, the dip coating method, the curtain coating method, the extrusion coating method, the rod coating method or the roll coating method. Among all, the rod coating method is particularly preferred. The membrane thickness after drying preferably ranges from 0.1 to 10 μm. The heat drying can be conducted at 15° C. to 110° C. To sufficiently conduct the crosslinking, it is preferably conducted at 60° C. to 100° C., particularly preferably at 80° C. to 100° C. The drying may be carried out for 1 minute to 36 hours, preferably from 1 minute to 30 minutes. Similarly, the pH value may be adjusted to the optimum level of the crosslinking agent employed. In the case of using glutaraldehyde, the pH value preferably ranges from 4.5 to 5.5, in particular 5.

The orientation film is formed on the transparent support or on the undercoating layer. The orientation film can be obtained by crosslinking the polymer as described above and then rubbing the surface. The orientation film is provided in order to define the orientation direction of the liquid crystal discotic compound to be provided thereon.

For the rubbing treatment, use can be made of a treating method widely employed in the liquid crystal orientation step for LCD. Namely, it is possible to use the method of rubbing the surface of the orientation film in a definite direction with paper, gauze, felt, rubber or nylon or polyester fiber, etc. In general, it may be conducted by rubbing the orientation film with, for example, a fabric having filaments with uniform length and thickness evenly planted therein.

(Optically Anisotropic Layer)

The optically anisotropic layer of the optical compensation sheet is formed on the orientation film. It is preferred that the optically anisotropic layer is a layer comprising a compound having a discotic structural unit and having negative birefringence. The optically anisotropic layer is a layer of a low-molecular weight discotic liquid crystalq compound (monomer) or a layer a polymer obtained by polymerizing (hardening) a polymerizable discotic liquid crystal compound. Examples of the discotic compounds include benzene derivatives reported by C. Destrade et al., Mol. Crysr. Liq. Cryst., vol. 71, p. 111 (1981); truxene derivatives reported by C. Destrade et al., Mol. Crysr. Liq. Cryst., vol. 122, p. 141 (1985) and Physics Lett, A. Vol. 78, p. 82 (1990); cyclohexane derivatives reported by Kohne et al., Angew. Chem. Soc. Chem. Comm., vol. 96, p. 70 (1984); and azacrown and phenylacetylene microcycles reported by J. M. Lehn, J. Chem. Commun., p. 1794 (1985) and J. Zhang et al., J. Am. Chem. Soc., vol. 116, p. 2655 (1994)). A discotic compound generally has a structure in which such a molecule serving as a mother nucleus is radially substituted by a linear alkyl group, an alkoxy group or a substituted benzoyloxy group. Discotic compounds include liquid crystal discotic liquid crystals. Optically anisotropic layers formed from discotic compounds include those wherein a low-molecular discotic liquid crystal having a group undergoing a reaction due to heat or light is reacted for polymerization or crosslinking to form a polymer and thus losses its liquid crystal nature. Discotic compounds are described in JP-A-8-50206.

It is preferable that the optically anisotropic layer is a layer comprising a compound having a discotic structural unit and having negative birefringence wherein the discotic structural unit plane is located at an angle to the transparent support plane and the angle between the discotic structural unit plane and the transparent support plane changes in the depth direction of the optically anisotropic layer.

The angle (inclination) of the discotic structural unit plane is generally in the depth direction of the optically anisotropic layer and increases or decreases with an increase in the distance from the bottom plane of the orientation film of the optically anisotropic layer. It is preferable that this angle of inclination increases with an increase in the distance. Changes in the inclination angle include continuous increase, continuous decrease, intermittent increase, intermittent decrease, change including continuous increase with continuous decrease, intermittent change including increase and decrease, etc. Such an intermittent change involves an area wherein the inclination angle does not change in the depth direction. It is preferable that the inclination angle increases or decreases as a whole, though there is an area with no change. It is also preferred that the inclination angle increases as a whole, in particular, continuously.

The optically anisotropic layer can be obtained in general by coating a solution containing a discotic compound and other compounds dissolved in a solvent onto the orientation film, drying, then heating to the discotic nematic phase-forming temperature, and then cooling while maintaining the orientation (the discotic nematic phase). Alternatively, the optically anisotropic layer may be obtained by coating a solution containing a discotic compound and other compounds (together with, for example, a polymerizable monomer and a photopolymerization initiator) dissolved in a solvent onto the orientation film, drying, then heating to the discotic nematic phase-forming temperature, polymerizing (by, for example, UV irradiation) and then cooling. The discotic nematic liquid crystal phase-solid phase transition temperature of the discotic liquid crystal compound preferably ranges from 70 to 300° C., particularly preferably from 70 to 170° C.

The angle of inclination of the discotic unit in the support side can be controlled generally by selecting an appropriate discotic compound or orientation film material, or by selecting an appropriate rubbing method. The angle of inclination of the discotic unit in the front face side (atmosphere side) can be controlled generally by selecting an appropriate discotic compound or compounds (for example, a plasticizer, a surfactant, a polymerizable monomer and a polymer) to be used together with the discotic compound. The extent of the inclination angle change can be similarly controlled by the above selection.

As the plasticizer, surfactant and polymerizable monomer, any compounds may be used so long as having an adequately compatibility with the discotic compound, being capable of changing the inclination angle of the discotic liquid crystal compound or not interfering the orientation. Among all, it is preferred to use a polymerizable monomer (for example, compounds having vinyl group, vainglory group, arylakyl group and methacryloyl group). Such a compound is used generally in an amount of form 1 to 50% by mass (weight), preferably form 5 to 30% by mass, based on the discotic compound.

As the polymer, any polymer can be used so long as being compatible with the discotic compound and being capable of changing the inclination angle of the discotic liquid crystal compound. As examples of the polymer, cellulose esters may be cited. Preferable examples of the cellulose esters include cellulose acetate, cellulose acetate propionate, hydroxypropylcellulose and cellulose acetate butyrate. The polymer is used in an amount of generally from 0.1 to 10% by mass (weight), preferably from 0.1 to 8% by mass and particularly preferably from 0.1 to 5% by mass, based on the discotic compound so as not to interfere the orientation of the discotic liquid crystal compound.

(Polarizing Plate)

A polarizing plate has a layered structure composed of an optical compensation sheet, which comprises a polymer film, an orientation film formed thereon and an optically anisotropic layer of fixing the orientation of liquid crystal molecules, a polarizer, and a transparent protective film layered in this order. As the transparent protective layer, use may be made of a commonly employed cellulose acetate film. Examples of the polarizer include an iodine-type polarizer, a dye-type polarizer using a dichroic dye and a polyene-type polarizer. Iodine-type polarizers and dye-type polarizers are generally produced with the use of polyvinyl alcohol-based films. The relationship between the slow axis of the polymer film and the transmission axis of the polarizer varies depending on the type of the liquid crystal display to which it is mounted. In a liquid crystal display of TN, MVA or OCB type, these axes are located substantially in parallel. In a liquid crystal display of the reflection type, it is preferred that these axes are located substantially at an angle 45°.

(Liquid Crystal Display)

The optical compensation sheet or the polarizing plate is advantageously used in a liquid crystal display. Liquid crystal displays of the TN, MVA and OCB modes each has a liquid crystal cell and two polarizing sheets provided in both sides thereof. In the liquid crystal cell, liquid crystals are retained between two electrode substrates. An optical compensation sheet is provided between the liquid crystal cell and one polarizing sheets, or two optical compensation sheets are provided between the liquid crystal cell and both polarizing sheets. In a liquid crystal display of the OCB mode, an optical compensation sheet may have an optically anisotropic layer containing a discotic compound or a rod-shaped liquid crystal compound on the polymer film. The optically anisotropic layer is formed by orienting the discotic compound (rod-shaped liquid crystal compound) and fixing the orientation state. A discotic compound generally have a large birefringence. Also, a discotic compound has various orientation states. Therefore, use of such a discotic compound makes it possible to produce an optical compensation sheet having optical properties that cannot be obtained by using the existing stretched bifringent films. Optical compensation sheets using discotic compounds are described in JP-A-6-214116, U.S. Pat. No. 5,583,679, U.S. Pat. No. 5,646,703 and German Patent 3,911,620.

In a polarizing sheet, the above-described polymer film can be used as a transparent protective film located between the liquid crystal cell and the polarizer. The polymer film is used as a transparent protective film for one polarizing sheet alone (located between the liquid crystal cell and the polarizer). Alternatively, two polymer films as described above are employed respectively for transparent protective films for both of the polarizing sheets (located between the liquid crystal cell and the polarizers). It is preferred that the liquid crystal cell is in the OCB mode or the TN mode. A liquid crystal cell of the OCB mode is used in a liquid crystal display of the bend orientation mode, wherein rod-shaped liquid crystal molecules are oriented substantially in opposite directions (symmetrically) in the upper part and lower part of the liquid crystal cell, disclosed in U.S. Pat. No. 4,583,825 and U.S. Pat. No. 5,410,422. Since the rod-shaped liquid crystal molecules are symmetrically oriented in the upper and lower part of the liquid crystal cell, such a liquid crystal cell of the bend orientation mode has a self-optical compensatory function. Thus, this liquid crystal mode is called OCB (optically compensatory bend) liquid crystal mode. Liquid crystal displays of the OCB mode have a merit of having a high response speed. In a liquid crystal cell of the TN mode, rod-shaped liquid crystal molecules are substantially horizontally oriented under no voltage loading and further oriented in 60 to 120° twisted state. Liquid crystal displays of the TN mode have been most frequently employed as color TFT liquid crystal displays and reported in a large number of documents.

The invention will now be illustrated in more detail by reference to the following examples, but these examples should not be construed as limiting the scope of the invention in any way.

### EXAMPLE 1

(Production of Cellulose Ester Film CF)

The following composition was put into a mixing tank and stirred under heating to dissolve individual components. Thus, a cellulose acetate solution A was prepared.

(Composition of cellulose acetate solution A)

| | | |
|---|---|---|
| Cellulose acetate (acetylation | 100.0 | parts by mass (weight) |
| degree 60.9%) | | |
| Triphenyl phosphate (plasticizer) | 7.0 | parts by mass |
| Biphenyl diphenyl phosphate (plasticizer) | 4.0 | parts by mass |
| Methylene chloride (first solvent) | 402.0 | parts by mass |
| Methanol (second solvent) | 60.0 | parts by mass |

The following composition was put into a dispersing machine and stirred to thereby disperse and mix individual components. Thus, a matting agent solution was prepared.

(Composition of matting agent solution)

| | | |
|---|---|---|
| Silica particles (average diameter 16 nm) | 2.0 | parts by mass (weight) |
| (AEROSIL R972, manufactured | | |
| by Nippon Aerosil) | | |
| Methylene chloride (first solvent) | 76.3 | parts by mass |
| Methanol (second solvent) | 11.4 | parts by mass |
| Cellulose acetate solution A | 10.3 | parts by mass |

The following composition was put into a mixing tank and stirred under heating to thereby dissolve individual components. Thus, a retardation raising agent solution was prepared.

(Composition of matting agent solution)

| | |
|---|---|
| Retardation raising agent shown below | 19.8 parts by mass (weight) |
| UV absorber (A) shown below | 0.07 parts by mass |
| UV absorber (B) shown below | 0.13 parts by mass |
| Methylene chloride (first solvent) | 58.4 parts by mass |
| Methanol (second solvent) | 8.7 parts by mass |
| Cellulose acetate solution A | 12.8 parts by mass |

Retardation Raising Agent:

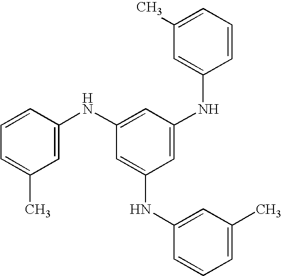

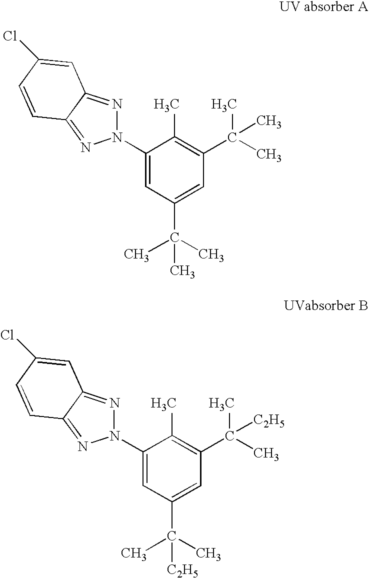

94.6 parts by mass (weight) of the cellulose acetate solution A, 1.3 parts by mass of the matting solution and 4.1 parts by mass of the retardation raising agent solution were each filtered and then mixed together. Then, the mixture was cast on a band caster. The ratio by mass (weight) of the retardation raising agent to cellulose acetate was 4.6%. At the residual solvent content of 30%, the film was stripped off from the band. At 130° C., the film containing 13% by mass of the residual solvent was vertically 28% stretched with a tenter. Then it was held at 140° C. for 30 seconds while maintaining the width at the stretched level. After taking off clips, it was dried at 140° C. for 40 minutes to give a cellulose acylate film CF. An The residual solvent content in the obtained cellulose acylate film was 0.2% and the film thickness thereof was 72 μm.

(Preparation of Alkali Saponification Solutions S-1 to S-5)

An alkali saponification solution S-1 (existing type) was prepared by using, per 100 g of the saponification solution composition, 5 g of an alkali (potassium hydroxide), 15 g of a high-boiling solvent (propylene glycol (188° C.)), pure water (having electrical resistivity of 1 MΩ or more), 64 g of a low-boiling solvent (isopropyl alcohol (82° C.)) and 1 g of a nonionic surfactant (polyoxyethylene cetyl ether).

Similarly, alkali saponification solutions S-1 to S-5 were prepared by lowering the contents of three components, i.e., the alkali, the high-boiling solvent and pure water to ½, ⅓, ¼ and ⅙ each based on the alkali saponification solution S-1 (see Table 1).

TABLE 1

| | | Three | | High- | | Low- | |
|---|---|---|---|---|---|---|---|
| Alkali | | components:low- | | boiling | | boiling | |
| saponification | Three | boiling | Alkali | solvent | Pure | solvent | |
| solution | components | solvent | KOH | PG | water | IPA | Surfactant |
| S-1 | 1 | 35:65 | 5 g | 15 g | 15 g | 64 g | 1 g |
| S-2 | ½ | 21:79 | 2.5 g | 7.5 g | 7.5 g | 64 g | 1.21 g |
| S-3 | ⅓ | 15:85 | 1.67 g | 5 g | 5 g | 64 g | 0.87 g |
| S-4 | ¼ | 12:88 | 1.25 g | 3.75 g | 3.75 g | 64 g | 0.68 g |
| S-5 | ⅕ | 8:92 | 0.83 g | 2.5 g | 2.5 g | 64 g | 0.47 g |

PG: propylene glycol.
IPA: isopropyl alcohol.
(Saponification treatment: Production of films KF-1 to KF-5)

The cellulose acetate film CF produced above was saponified with the alkali saponification solutions S-1 to S-5 in the following manner.

The cellulose acetate CF film was heated to 40° C. by passing through a dielectric heater having heated to 60° C. and then coated with the alkali saponification solution S-1 having been maintained at 40° C. with the use of a rod coater at 19 g/m² (lower limit of coating dose+1 g/m²). After holding under a steam-type far infrared heater (NORITAKE Co., Ltd.) having been heated to 100° C. for 7 seconds, 3 cc/m² of pure water was applied by using the same rod coater, thereby washing away the alkali. During this procedure, the film temperature was maintained at 40 to 45° C. Next, water washing with a fountain coater and draining with an air knife were repeated thrice to wash away the alkali. Then, the film was held in a drying zone at 70° C. for 5 seconds to give a saponified film KF-1. The liquid viscosity and liquid density of the alkali saponification solution S-1 were as listed in Table 2.

Saponified films KF-2 to KF-5 were produced by repeating the above procedures and the saponification treatment, while transporting the cellulose acetate film CF, the but using the alkali saponification solutions S-2 to S-5 as substitutes for the alkali saponification solution S-1 and employing the coating amounts (lower limit of coating dose+1 g/m²) as listed in Table 2. The liquid viscosities and liquid densities of the alkali saponification solutions S-2 to S-5 were as listed in Table 2.

(Method of Evaluating Polymer Film)

The contact angles of the saponified films KF-1 to KF-5 thus obtained were measured in the following manner. The results of the contact angle measurement and the planar state evaluation results are given in Table 2.

(Measurement of Contact Angle)

After dropping water on the sample surface, the angle of the water drop edge to the sample surface was measured. (Measurement was made by enlarging the sample photo and processing the image.)

The saponified films KF-1 to KF-5 obtained above were subjected to haze measurement with an optical test machine model NDH-300A manufactured by NIPPON DENSHOKU INDUSTRIES, Co., Ltd.).

TABLE 2

| | | Three | | | | | |
|---|---|---|---|---|---|---|---|
| Alkali | | components:low- | | | | | |
| saponification | Three | boiling | | | Coating | Contact | Planar |
| solution | components | solvent | Viscosity | Density | amount | angle | state |
| S-1 | 1 | 35:65 | 3.05 cP | 0.874 | 19 g/m² | 23.3° | B |
| S-2 | ½ | 21:79 | 2.18 cP | 0.832 | 15 g/m² | 25.0° | A |
| S-3 | ⅓ | 15:85 | 1.84 cP | 0.814 | 14 g/m² | 29.8° | A |
| S-4 | ¼ | 12:88 | 1.66 cP | 0.805 | 13 g/m² | 33.2° | A |
| S-5 | ⅙ | 8:92 | 1.48 cP | 0.794 | 12 g/m² | 40.2° | A |

A: No problem.
B: Generation of defects in coated plane face caused by insufficient washing

With lowering the contents of the three components (i.e., the alkali, the high-boiling solvent and pure water) to ½, ⅓, ¼ and ⅙ of the alkali saponification solution S-1, the viscosity and density were lowered and thus the lower limit of the coating amount could be thus reduced.

With lowering the contents of the three components (i.e., the alkali, the high-boiling solvent and pure water) to ½, ⅓, ¼ and ⅙ of the alkali saponification solution S-1, the contact angle in the case of conducted the saponification by coating in an amount (the lower limit of the coating amount+1 g/m²) was elevated. However, the saponification to the desired level (45° or less) could be conducted even at ⅙. Moreover, all samples suffered from no problem in the planar states (excluding the saponification solution S-1 of the existing type) after the completion of the saponification. Furthermore, the saponified films KF-1 to KF-5 showed each a favorable and low haze.

In the case of using the alkali saponification solution S-1, the content of the high-boiling solvent in the waste water exceeded 300 g/min. With lowering the contents of the three components (i.e., the alkali, the high-boiling solvent and pure water) to ½, ⅓, ¼ and ⅙ of the alkali saponification solution S-1, the content (g/min) of the high-boiling solvent in the waste water was reduced as less than 150 g/min, less than 100 g/min, less than 90 g/min and less than 80 g/min. That is to say, use of the saponification solution having the contents of the three components ½ times as much as those in the saponification solution S-1 made it possible to cut down the content of the high-boiling solvent in the waste water to ½ or less. Similarly, use of the saponification solution having the contents of the three components ⅙ times as much as those in the saponification solution S-1 made it possible to cut down the content of the high-boiling solvent in the waste water to ¼ or less.

(Formation of Orientation Film)

On the saponified face of each of the cellulose acetate film CF and the saponified films KF-1 to KF-5, a coating solution for orientation film, which comprised 20 parts by mass of the polyvinyl alcohol shown below, 360 parts by mass of water, 120 parts by mass of methanol and 0.5 part by mass of glutaraldehyde, was applied with a rod coater at 30 cc/m². After drying with a warm air stream at 60° C. for 60 seconds and with a hot air stream at 90° C. for 150 seconds, rubbing was conducted by using a velvet cloth rubbing roll provided vertically to the transportation direction to thereby form an orientation film.
Denatured Polyvinyl Alcohol: 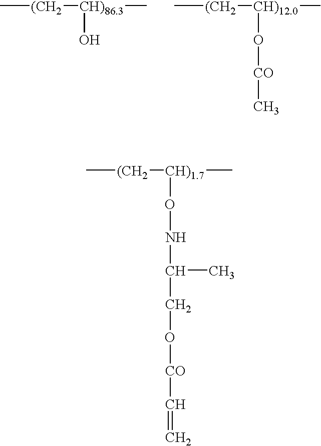
(Formation of Optically Anisotropic Layer)

On each of the orientation films formed on CF and KF-1 to KF-5 as described above, a solution of 41.01 parts by mass (weight) of the discotic compound shown below, 1.22 parts by mass of ethylene oxide-denatured trimethylolpropane triacrylate (V#360, manufactured by OSAKA ORGANIC CHEMICAL INDUSTRY, Ltd.), 2.84 parts by mass of a polyfunctional acrylate monomer (NK ESTER A-TMMT, manufactured by SHIN NAKAMURA CHEMICAL Co., Ltd.), 0.90 part by mass of cellulose acetate butyrate (CAB551-0.2, manufactured by EASTMAN CHEMICAL), 0.23 part by mass of cellulose acetate butyrate (CAB531-1, manufactured by EASTMAN CHEMICAL), 1.35 parts by mass of a photopolymerization initiator (Irgacure 907, manufactured by Ciba-Geigy) and 0.45 part by mass of a sensitizer (Kayacure DETX, manufactured by NIPPON KAYAKU Co., Ltd.) dissolved in 102 parts by mass of methyl ethyl ketone was applied with a #4 wire bar. Next, it was heated in a hot-air stream zone connected thereto at 130° C. for 2 minutes to thereby orient the discotic compound. Finally, it was UV-irradiated in an atmosphere at 80° C. at a film face temperature of about 100° C. with the use of a high pressure mercury lamp at 120 W/cm for 0.4 second to polymerize the discotic compound, thereby forming an optically anisotropic layer. Thus, optical compensation sheets CHF and KHF1 to KHF-5 were produced. The retardation value of the optically anisotropic layer measured at a wavelength of 633 nm was 45 nm. The average angle (inclination) between the discotic face and the first transparent support was 39° C.
Discotic Compound: 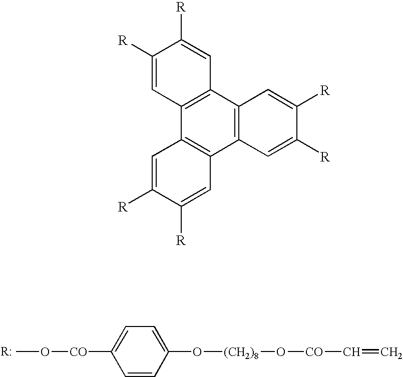
(Method of Evaluating Optical Compensation Sheet)

The obtained optical compensation sheets CHF and KHF-1 to KHF-5 were each sandwiched between two polarizing sheets in the crossed Nicols configuration and unevenness in the transmitted light was observed with the naked eye. Coating unevenness in the optically anisotropic layer or orientation unevenness of the discotic compound was specified and sensorily evaluated in four grades.

A: No unevenness (no subject among 100 can recognize).

B: Slight unevenness (1 to 3 subjects among 100 can recognize).

C: Weak unevenness (4 to 20 subjects among 100 can recognize).

D: Strong unevenness (20 or more subjects among 100 can recognize).

Each optical compensation sheet was cut into a piece (30 cm×25 cm) and allowed to stand at 25° C. and 60% RH for 1 day. Next, 100 sellotape (No. 405 manufactured by NICHIBAN Co., Ltd.) pieces (1.2 cm in width, 10 cm in length) were put on the optically anisotropic layer side and then stripped off one by one. Thus, peeling between the film and the orientation film was examined. The relative order of adhesiveness was evaluated based on the number of sellotape pieces having been stripped until peeling between the coating layers arose.

Table 3 shows the evaluation results.

TABLE 3

| Optical | Unevenness in | Number of pieces at |
|---|---|---|
| compensation sheet | transmitted light | abnormal peeling |
| CHF | D | 100 |
| KHF-1 | A | 0 |
| KHF-2 | A | 0 |
| KHF-3 | A | 0 |
| KHF-4 | A | 0 |
| KHF-5 | A | 0 |

As Table 3 indicates, the samples KHF-1 to KHF-5 having been subjected to the saponification treatment of the invention showed highly favorable results in the tests on unevenness in transmitted light and peeling similar to the sample KHF-1 having been subjected to the saponification with the conventional alkali saponification solution S-1. In contrast, the non-surface treated sample CHF could not be used as an optical compensation sheet.

### EXAMPLE 2

(Production of Saponified Films KF-6 to KF-11)

Saponified films KF-6 to KF-11 were produced as in KF-4 of Example 1 but using alkali saponification solutions S-6 to S-11 which had been prepared by changing the content surfactant in the alkali saponification S-4 containing the three components in an amount corresponding to ¼ of that in the alkali saponification S-4 of the existing type as listed in Table 4. Table 5 shows the evaluation results.

TABLE 4

| Alkali | | | High-boiling | | Low-boiling | |
|---|---|---|---|---|---|---|
| saponification | Surfactant | Alkali | solvent | Pure | solvent | |
| solution | content | KOH | PG | water | IPA | Surfactant |
| S-6 | 0.0 wt % | 1.25 g | 3.75 g | 3.75 g | 64 g | 0 g |
| S-7 | 0.2 wt % | 1.25 g | 3.75 g | 3.75 g | 64 g | 0.15 g |
| S-8 | 0.5 wt % | 1.25 g | 3.75 g | 3.75 g | 64 g | 0.36 g |
| S-9 | 1.0 wt % | 1.25 g | 3.75 g | 3.75 g | 64 g | 0.73 g |
| S-10 | 2.0 wt % | 1.25 g | 3.75 g | 3.75 g | 64 g | 1.46 g |
| S-11 | 3.0 wt % | 1.25 g | 3.75 g | 3.75 g | 64 g | 2.19 g |

TABLE 5

| Alkali | | | | | | |
|---|---|---|---|---|---|---|
| sapon- | | | | | | |
| ification | Surfactant | | | Coating | Contact | Planar |
| solution | content | Viscosity | Density | amount | angle | state |
| S-6 | 0.0 wt % | 1.62 cP | 0.803 | 13 g/m² | 40.5° | B |
| S-7 | 0.2 wt % | 1.62 cP | 0.803 | 13 g/m² | 30.6° | A |
| S-8 | 0.5 wt % | 1.64 cP | 0.804 | 13 g/m² | 31.7° | A |
| S-9 | 1.0 wt % | 1.68 cP | 0.805 | 13 g/m² | 32.2° | A |
| S-10 | 2.0 wt % | 1.74 cP | 0.806 | 13 g/m² | 32.5° | A |
| S-11 | 3.0 wt % | 1.79 cP | 0.808 | 13 g/m² | 32.7° | A |

A: No problem.
B: Turning into white allover the face.

Although the viscosity and density were slightly elevated with an increase in the surfactant content, the lower limit of the coating amount was 12 to 13 g/m². Thus, coating was conducted at 13 g/m² in every case for the saponification.

As a result, the sample with 0.0% by mass of the surfactant showed a larger contact angle than other samples and turned into white allover the face. This is because the plasticizer and retardation raising agent having been extracted from the polymer film remained on the base surface.

Other samples showed no problem in the planar state but the 0.2% by mass sample showed the minimum contact angle. This is seemingly because the surfactant, that had been added exceeding the required level, remained together with the plasticizer and the retardation raising agent on the base surface.

To obtain the data supporting the above assumption, the plasticizer and retardation raising agent concentrations in the first waste liquor from the step of washing away the alkali solution from the polymer film were determined. As a result, the plasticizer and retardation raising agent concentrations attained the maximum levels in the waste solution of the case with the surfactant content of 0.2% by mass.

The results of Examples 1 and 2 indicate that it is preferable from the viewpoints of the material cost, wastewater load to be treated and plane state to prepare a saponification solution to which an alkali KOH, a high-boiling solvent PG and the surfactant are added each in the minimum amount.

By the saponification treatment with the use of the alkali saponification solution according to an exemplary embodiment of the invention, the amount of the coating solution can be reduced. Moreover, the saponification treatment can be carried out with the use of the alkali, the high-boiling solvent and the surfactant each in the minimum amount, which enables considerable reduction in the material cost and a decrease in the wastewater load to be treated.

Since the saponification can be carried out with the use of the alkali, the high-boiling solvent and the surfactant each in the minimum amount, furthermore, the water-washing efficiency can be elevated in the step of washing away the saponification solution and thus the saponification surface treatment with improved qualities can be conducted.

Furthermore, the high-boiling solvent content in the wastewater can be largely lowered thereby compared with the existing saponification solutions.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-152510 filed May 25 of 2005, the contents of which are incorporated herein by reference.

What is claimed is:

1. A method for alkali saponifying a polymer film, which comprises the steps of:
coating a polymer film at a temperature of room temperature or higher with an alkali solution comprising an alkali, a high-boiling solvent, a low-boiling solvent, and water, wherein a weight ratio of the high-boiling solvent to the alkali is from 2 to 4, a weight ratio of the water to the alkali is from 2 to 4, and a weight ratio of (the alkali+the high-boiling solvent+the water) to the low-boiling solvent is from 25:75 to 2:98; and
washing away the alkali solution from the polymer film.

2. The method according to claim 1, which further comprises the step of maintaining the temperature of the polymer film at room temperature or higher.

3. The method according to claim 2, which further comprises the step of preliminarily heating the polymer film at room temperature or higher.

4. The method according to claim 1, wherein each of the steps is performed while transporting the polymer film.

5. The method according to claim 4, wherein the polymer film is continuously transported.

6. The method according to claim 1; wherein the alkali solution has a concentration of 0.05 to 1 mol/l, and the alkali solution is coated on the polymer film in an amount of 1 to 500 cc/m².

7. The method according to claim 1, wherein the alkali is an alkali metal hydroxide, and at least one of the high-boiling solvent and the low-boiling solvent is one or more organic solvents selected from the group consisting of alcohols having 8 or less carbon atoms, ketones having 6 or less carbon atoms, esters having 6 or less carbon atoms and polyhydric alcohols having 6 or less carbon atoms.

8. The method according to claim 1, wherein the alkali solution comprises at least one surfactant selected from the group consisting of a nonionic surfactant, an anionic surfactant, a cationic surfactant and an amphoteric surfactant.

9. The method according to claim 8 wherein the alkali solution has a concentration of the at least one surfactant of 0.05 to 5% by weight.

10. The method according to claim 8, wherein the at least one surfactant is represented by formula (1):
R¹-L¹-Q¹
wherein R¹ represents an alkyl group having 8 or more carbon atoms; L¹ represents a group linking R¹ and Q¹, and L¹ represents a direct bond or a divalent liking group; and Q¹ represents a nonionic hydrophilic group or an anionic hydrophilic group.

11. The method according to claim 8, wherein the at least one surfactant is a nonionic surfactant represented by formula (2):
R²-L²-Q²
wherein R² represents an alkyl group having 8 or more carbon atoms; L² represents a group linking R² and Q², and L² represents a direct bond or a divalent liking group; and Q² represents a nonionic hydrophilic group selected from the group consisting of a polyoxyethylene unit having a polymerization degree of 5 to 150, a polyglycerol unit having a polymerization degree of 3 to 30 and a hydrophilic sugar chain unit.

12. The method according to claim 8, wherein the at least one surfactant is an anionic surfactant represented by formula (3):
R³-L³-Q³
wherein R³ represents an alkyl group having 8 or more carbon atoms; L³ represents a divalent linking group having a polar partial structure comprising at least one unit selected from the group consisting of —O—, —CO—, —NR⁵—, —OH, —CH═CH— and —SO₂—, and R⁵ represents an alkyl group having from 1 to 5 carbon atoms; and Q³ represents an anionic group.

13. The method according to claim 1, wherein the alkali solution has a surface tension of 45 mN/m or less and a viscosity of 0.8 to 20 mPa·s.

14. The method according to claim 1, wherein the alkali solution has a density of 0.65 to 1.05 g/cm³.

15. The method according to claim 1, wherein the alakali solution has an electric conductivity of 1 to 100 mS/cm.

16. The method according to claim 1, wherein the polymer film is a cellulose ester film.

17. A surface-saponified cellulose ester film produced by a method of claim 16.

18. An optical film comprises a surface-saponified cellulose ester film according to claim 17.
